(19) United States
(12) Patent Application Publication
(10) Pub. No.: US 2012/0265681 A1
(43) Pub. Date: Oct. 18, 2012

(54) DYNAMIC CREDIT LIMIT INCREASE

(75) Inventor: ERIK STEPHEN ROSS, Charlotte, NC (US)

(73) Assignee: BANK OF AMERICA CORPORATION, Charlotte, NC (US)

(21) Appl. No.: 13/088,037

(22) Filed: Apr. 15, 2011

(51) Int. Cl. G06Q 40/00

(52) U.S. Cl. 705/44

(57) ABSTRACT

In general terms, embodiments of the present invention relate to methods and apparatuses for dynamically increasing a credit limit associated with a credit account. For example, in some embodiments, a method is provided that includes: (a) receiving transaction information associated with a transaction, where the transaction involves a credit account, and where the credit account has a credit limit; (b) determining, based at least partially on the transaction information, that at least a predetermined portion of the credit limit (e.g., 90% of the credit limit, the total credit limit, etc.) will be used as a result of the transaction; and/or (c) increasing the credit limit based at least partially on the determining that at least a predetermined portion of the credit limit will be used. In some embodiments, the method further includes: (a) determining, after increasing the credit limit, that the credit account has available credit sufficient to cover the transaction; and (b) authorizing the transaction based at least partially on the determining that the credit account has available credit sufficient to cover the transaction.

### BACKGROUND

Financial institution customers are constantly looking for new and useful ways to better manage their finances. This is particularly so given that most customers have multiple financial accounts and the consequences associated with mismanaging or forgetting about any one of them can lead to unexpected and/or unwanted outcomes. For example, a customer may go over limit on his credit card account and incur a related over limit fee by engaging in a transaction that he mistakenly believes his account can cover. Accordingly, there is a need to provide methods and apparatuses that help customers manage their finances in ways that avoid or reduce unexpected or unwanted outcomes.

### SUMMARY OF SELECTED EMBODIMENTS OF THE PRESENT INVENTION

The following presents a simplified summary of the present disclosure in order to provide a basic understanding of some aspects of the invention. This summary is not an extensive overview of the present invention. It is not intended to identify key or critical elements of the invention or to delineate the scope of the invention. The following summary merely presents some concepts of the invention in a simplified form as a prelude to the more detailed description provided below.

In general terms, embodiments of the present invention relate to methods and apparatuses for dynamically increasing a credit limit associated with a credit account. For example, in some embodiments, a method is provided that includes: (a) receiving transaction information associated with a transaction, where the transaction involves a credit account, a transaction machine, and a holder of the credit account, and where the credit account has a credit limit; (b) determining, based at least partially on the transaction information, that at least a predetermined portion of the credit limit will be used as a result of the transaction; and (c) increasing the credit limit based at least partially on the determining that at least the predetermined portion of the credit limit will be used. This credit limit increase may be temporary (e.g., where the credit limit is reduced back to the original level in the next statement cycle, etc.) or permanent (e.g., where the credit limit is maintained at the increased level for the next one or more statement cycles, etc.).

In some embodiments, the method further includes authorizing the transaction after increasing the credit limit. For example, in some embodiments, the method includes determining that, as a result of the credit limit increase, the credit account has available credit sufficient to cover the transaction. In some of these embodiments, the authorizing the transaction is based at least partially on the determining that the credit account has sufficient available credit. Also, in some embodiments, the credit limit is increased automatically (e.g., by an apparatus), dynamically, in real time, and/or during the transaction (e.g., sometime after the holder of the account arrives at the transaction machine to engage in the transaction and before the holder leaves the transaction machine, sometime while the holder is still standing at the transaction machine, etc.).

In other embodiments, the method alternatively includes authorizing the transaction before increasing the credit limit. For example, in some embodiments, the method includes determining that the credit limit will be increased so that the account will have available credit sufficient to cover the transaction. In some of these embodiments, the authorizing the transaction is based at least partially on the determining that the credit limit will be increased. For example, in some embodiments, an apparatus executing the method may approve an authorization request associated with the transaction because the apparatus has determined that the credit limit will be increased on the day or week following the transaction and that the increase will be by an amount sufficient to cover the transaction.

Additionally or alternatively, in some embodiments, the method includes: (a) prompting the holder to consent to a credit limit increase; and (b) receiving the holder's consent to the credit limit increase. In some of these embodiments, the increasing the credit limit is based at least partially on the receiving the holder's consent. Additionally or alternatively, in some embodiments, the holder is prompted to consent to the credit limit increase during the transaction and/or while the holder is still standing at the transaction machine. Thus, in such embodiments, the holder of the account is able to make a real-time decision at the transaction machine regarding whether the holder wants to consent to the credit limit increase (and/or, as explained in more detail herein, to incurring a service fee associated with the credit limit increase, to completing the transaction, and/or the like). In addition, in accordance with some embodiments, the holder is able to make these decisions discreetly, thereby avoiding any potential embarrassment associated with reaching the predetermined portion of the credit limit, increasing the credit limit, incurring the service fee, and/or the like.

Further, in some embodiments of the present invention, the method includes: (a) prompting the holder to consent to the credit limit increase; (b) receiving a notification that indicates that the holder does not consent to the credit limit increase; and (c) declining the transaction based at least partially on the receiving the notification. Still further in some embodiments, the method includes: (a) receiving a transaction history associated with the credit account; and (b) determining, based at least partially on the transaction history, a shortfall for the credit account over a future period of time (e.g., the rest of the day, through the end of the month, etc.). In some of these embodiments, the credit limit increase is based at least partially on the shortfall (e.g., the credit limit is increased by an amount sufficient to cover the estimated shortfall). Additionally or alternatively, in some embodiments, the method includes: (a) prompting the holder to select the amount of the credit limit increase; and (b) receiving the holder's selected amount for the credit limit increase. In some of these embodiments, the credit limit increase is based at least partially on the selected amount (e.g., the credit limit is increased by the holder's selected amount, the credit limit is increased by the holder's selected amount plus $250, etc.).

Other embodiments of the present invention provide an apparatus having: (a) a communication interface configured to receive, via a payment network, transaction information associated with a transaction, where the transaction involves a credit account, and where the credit account has a credit limit; and (b) a processor operatively connected to the communication interface and configured to: (i) determine, based at least partially on the transaction information, that at least a predetermined portion of the credit limit will be used as a result of the transaction; and (ii) increase the credit limit based at least partially on the processor determining that at least the predetermined portion of the credit limit will be used.

Still other embodiments of the present invention provide a computer program product having a non-transitory computer-readable medium. In some of these embodiments, the non-transitory computer-readable medium includes one or more computer-executable program code portions that, when executed by a computer, cause the computer to: (a) receive transaction information associated with a transaction, where the transaction involves a credit account, and where the credit account has a credit limit; (b) determine, based at least partially on the transaction information, that at least a predetermined portion of the credit limit will be used as a result of the transaction; (c) increase the credit limit based at least partially on the computer determining that at least the predetermined portion of the credit limit will be used; and (d) authorize the transaction based at least partially on the computer increasing the credit limit.

In still other embodiments, another method is provided that includes: (a) receiving an authorization request associated with a transaction, where the transaction involves a holder of a credit account and the credit account, and where the credit account has a credit limit; (b) determining that the account does not have available credit sufficient to cover the transaction; (c) prompting, during the transaction, the holder to consent to a credit limit increase, where the prompting occurs after the determining that the account does not have sufficient available credit; (d) receiving, during the transaction, the holder's consent to the credit limit increase; and (e) increasing the credit limit such that the account has available credit sufficient to cover the transaction, where the increasing the credit limit is based at least partially on the receiving the holder's consent.

In other embodiments, still another method is provided that includes: (a) presenting, by a holder of an account, account information at a transaction machine to engage in a transaction, where the account information is associated with a credit account involved in the transaction, and where the credit account has a credit limit; (b) receiving, by the holder and via a mobile device carried by the holder, a communication that indicates that the credit account does not have sufficient available credit to complete the transaction, where the receiving occurs while the holder is still at the transaction machine; and (c) consenting, by the holder and via the mobile device, to increasing the credit limit to complete the transaction, where the consenting occurs while the holder is still at the transaction machine.

### BRIEF DESCRIPTION OF THE DRAWINGS

Having thus described some embodiments of the present invention in general terms, reference will now be made to the accompanying drawings, where:

FIG. 1 is a flow diagram illustrating a general process flow for dynamically increasing a credit limit before authorizing a transaction, in accordance with an embodiment of the present invention;

FIG. 1A is a flow diagram illustrating a general process flow for dynamically increasing a credit limit after authorizing a transaction, in accordance with an embodiment of the present invention;

FIG. 2 is a flow diagram illustrating a more-detailed process flow for dynamically increasing a credit limit before authorizing a transaction, in accordance with an embodiment of the present invention;

FIG. 3 is a flow diagram illustrating a general process flow for dynamically increasing a credit limit based at partially on coverage provided through an insurance product, in accordance with an embodiment of the present invention;

FIG. 4 is a block diagram illustrating technical components of a system for dynamically increasing a credit limit and/or for providing one or more other credit services, in accordance with an embodiment of the present invention;

FIG. 4A is a block diagram illustrating technical components of a mobile device configured to provide and/or participate in a credit service, in accordance with an embodiment of the present invention;

FIG. 5 is a mixed block and flow diagram of a system for dynamically increasing a credit limit of a credit card account based at least partially on a transaction amount, in accordance with an embodiment of the present invention; and

FIG. 6 is a mixed block and flow diagram of a system for dynamically increasing a credit limit of a credit card account based at least partially on an estimated shortfall, in accordance with an embodiment of the present invention.

### DETAILED DESCRIPTION OF EMBODIMENTS OF THE PRESENT INVENTION

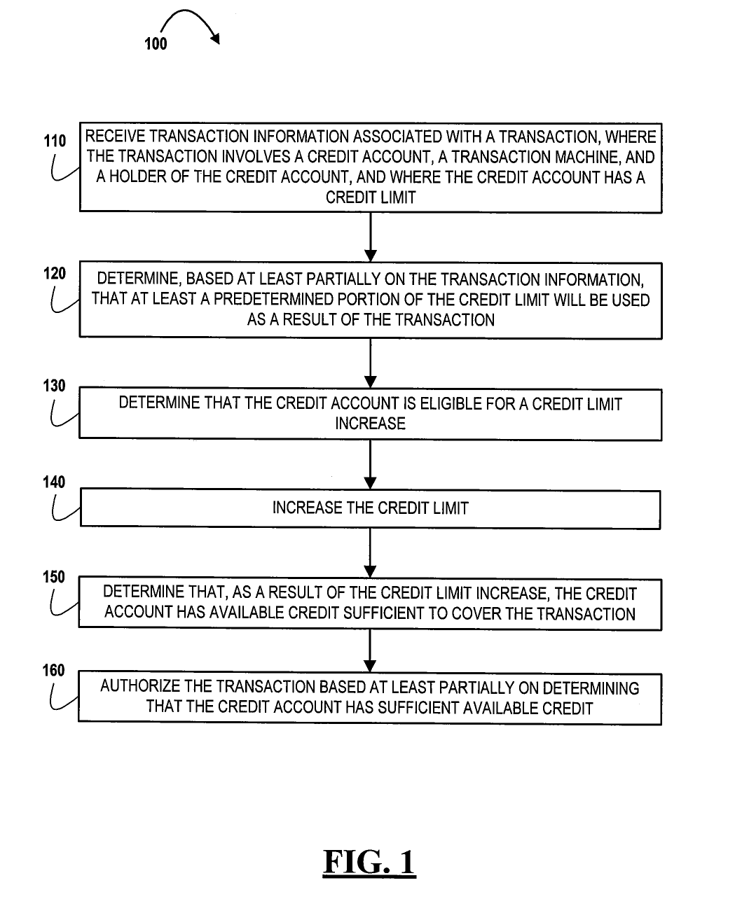

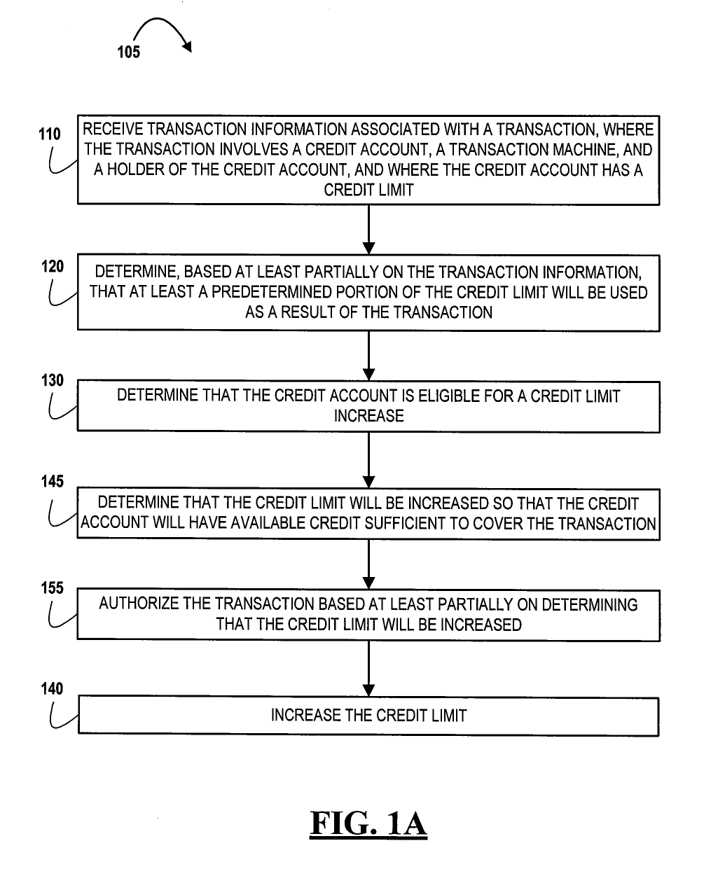

Referring now to FIG. 1, a general process flow 100 is provided for dynamically increasing a credit limit before authorizing a transaction, in accordance with an embodiment of the present invention. In some embodiments, the process flow 100 is performed by an apparatus (i.e., one or more apparatuses) having hardware and/or software configured to perform one or more portions of the process flow 100. In such embodiments, as represented by block 110, the apparatus is configured to receive transaction information associated with a transaction, where the transaction involves a credit account, a transaction machine (e.g., a POS device, ATM, etc.), and a holder of the credit account (and the user of the transaction machine), and where the credit account has a credit limit. As represented by block 120, the apparatus is also configured to determine, based at least partially on the transaction information, that at least a predetermined portion of the credit limit (e.g., 80% of the credit limit, all of the credit limit, etc.) will be used (e.g., met, reached, etc.) as a result of the transaction. In addition, as represented by block 130, the apparatus is further configured to determine that the credit account is eligible for a credit limit increase. As represented by block 140, the apparatus is further configured to increase the credit limit. As represented by block 150, the apparatus is configured to determine that, as a result of the credit limit increase, the credit account has available credit sufficient to cover the transaction. Additionally, as represented by block 160, the apparatus is configured to authorize the transaction based at least partially on determining that the credit account has sufficient available credit.

For simplicity, it will be understood that the portion of the process flow represented by block 120 is sometimes referred to herein as the “credit limit determination,” the portion of the process flow represented by block 130 is sometimes referred to herein as the “eligibility determination,” and the portion of the process flow represented by block 150 is sometimes referred to herein as the “sufficiency determination.” Also for simplicity, it will be understood that the portion of the process flow represented by block 140 is sometimes referred to herein as the “credit limit increase.” Further, the term “determine,” in some embodiments, is meant to have one or more of its ordinary meanings (i.e., its ordinary dictionary definition(s)), but that in other embodiments, that term is meant to have one or more of the ordinary meanings of one or more of the following terms: decide, conclude, verify, ascertain, find, discover, learn, calculate, observe, read, and/or the like. Further, in some embodiments, the phrase “based at least partially on,” in some embodiments, is meant to have one or more of its ordinary meanings, but in other embodiments, that phrase is meant to have one or more of the ordinary meanings of one or more of the following terms and/or phrases: as a result of, because of, after, if, when, in response to, and/or the like.

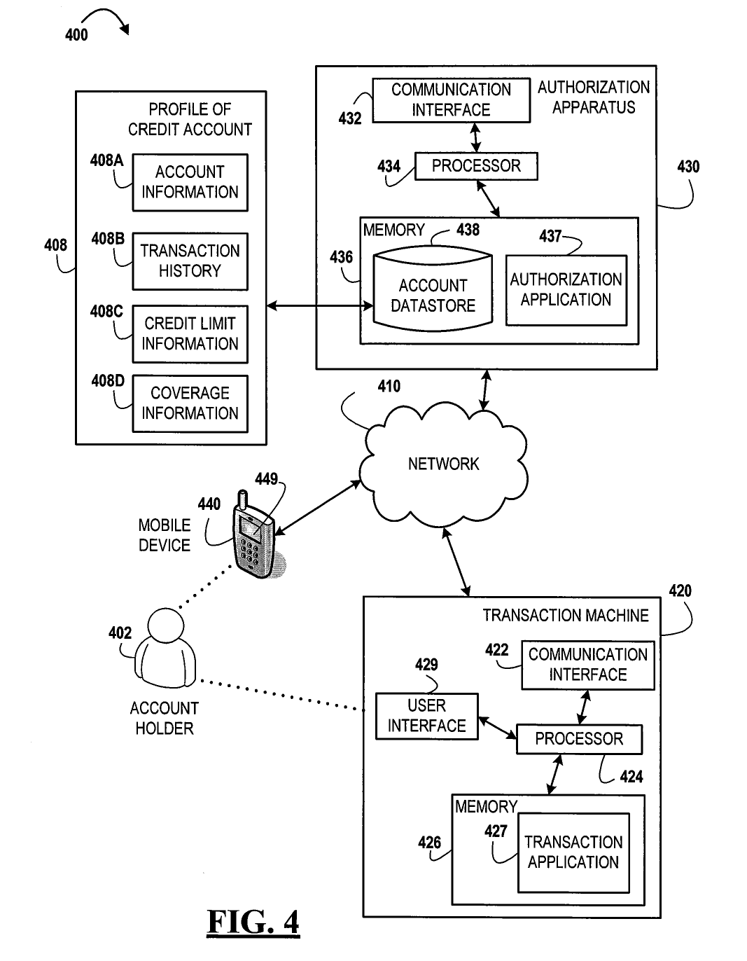

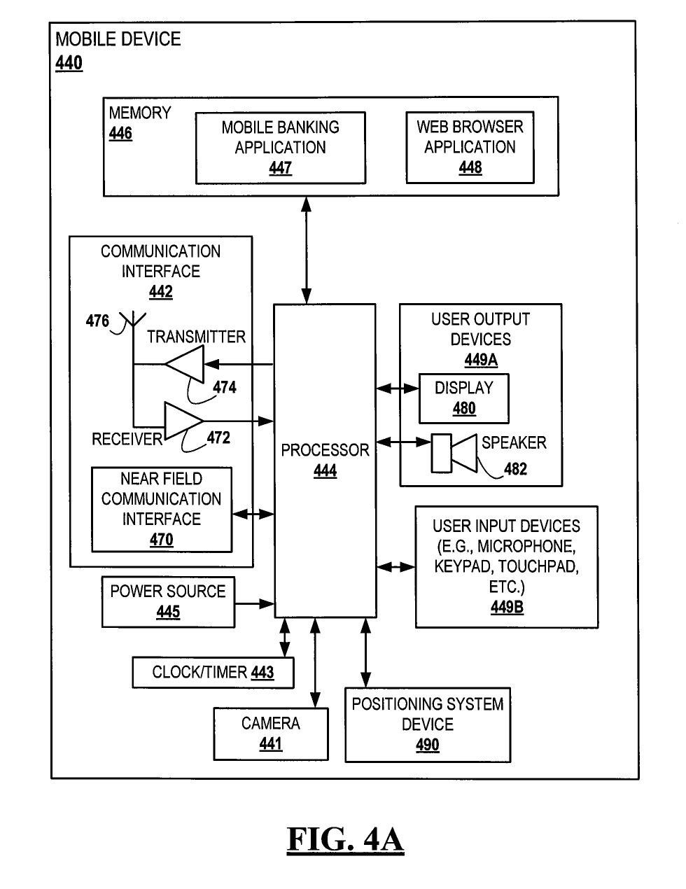

It will also be understood that the apparatus having the process flow 100 can include one or more separate and/or different apparatuses. For example, in some embodiments, one apparatus (e.g., the transaction machine 420 described in connection with FIG. 4, etc.) is configured to perform the portion of the process flow 100 represented by block 110, and a second apparatus (e.g., the authorization apparatus 430) is configured to perform the portions represented by blocks 120-160. As still another example, in some embodiments, a single apparatus (e.g., the authorization apparatus 430) is configured to perform each and every portion of the process flow 100. It will also be understood that, in some embodiments, a transaction machine (e.g., the transaction machine 420) is configured to perform one or more (or all) of the portions of the process flow 100, and that in some embodiments, that transaction machine includes, is included in, and/or is embodied as the transaction machine referred to in block 110.

Regarding block 110, the phrase “transaction machine,” as used herein, typically refers to an interactive computer terminal that is configured to initiate, perform, complete, and/or facilitate one or more financial transactions. Examples of transaction machines include, but are not limited to, automated teller machines (ATMs), point-of-sale (POS) devices (e.g., merchant terminals, etc.), self-service machines (e.g., vending machine, self-checkout machine, parking meter, etc.), public and/or business kiosks (e.g., an Internet kiosk, ticketing kiosk, bill pay kiosk, etc.), mobile phones (e.g., feature phone, smart phone, iPhone®, etc.), gaming devices (e.g., Nintendo WHO, PlayStation Portable®, etc.), computers (e.g., personal computers, tablet computers, laptop computers, etc.), personal digital assistants (PDAs), and/or the like.

In some embodiments, the transaction machine referred to in block 110 is located in a public place and is available for public use (e.g., on a street corner, on the exterior wall of a banking center, at a public rest stop, etc.). In other embodiments, the transaction machine is additionally or alternatively located in a place of business and available for public and/or business customer use (e.g., in a retail store, post office, banking center, grocery store, etc.). In accordance with some embodiments, the transaction machine is not owned by the user of the transaction machine and/or the holder of the account referred to in block 110. However, in other embodiments, the transaction machine is located in a private place, is available for private use, and/or is owned by the user of the transaction machine and/or the holder referred to in block 110.

Further regarding block 110, the transaction involving the holder and the transaction machine can include any number and/or type of transaction(s) involving a transaction machine. For example, in some embodiments, the transaction includes one or more of the following: purchasing, renting, selling, and/or leasing goods and/or services (e.g., groceries, stamps, tickets, DVDs, vending machine items, etc.); withdrawing cash; making payments to creditors (e.g., paying monthly bills; paying federal, state, and/or local taxes and/or bills; etc.); sending remittances; transferring balances from one account to another account; loading money onto stored value cards; donating to charities; and/or the like.

In some embodiments, the credit account, the transaction machine, and/or the apparatus having the process flow 100 are each controlled, serviced, held, owned, managed, operated, and/or maintained (collectively referred to herein as “maintained” for simplicity) by a single financial institution. For example, in some embodiments, the apparatus is maintained by a bank, the credit account is maintained by the bank, the transaction machine is owned by the bank, and the holder is a customer of the bank. Of course, it will be understood that, in some embodiments, the apparatus, the transaction machine, and/or the account are not maintained by the same financial institution (or any financial institution).

Also, the account referred to in the process flow 100 can include any number and/or type of credit account(s). For example, in some embodiments, the credit account includes a credit card account, line of credit (LOC) account, home equity line of credit (HELOC) account, store credit account (e.g., retail store account), and/or the like. As mentioned in block 110, the credit account has a credit limit (sometimes referred to as a “credit line”). For example, in some embodiments, the credit account is a credit card account having a credit limit of $15,000. In some embodiments, the phrase “credit limit” refers to the total amount of money that may be borrowed against the credit account. In some embodiments, the credit limit equals the total amount of credit available to the credit account at a given time plus the total amount of credit previously used by the credit account at that given time.

In some embodiments, the terms and/or conditions of the credit account are such that the credit limit for the credit account cannot (and/or will not) be exceeded as a result of a transaction. For example, in some embodiments, the apparatus having the process flow 100 may decline the transaction if the credit limit for the credit account will be exceeded as a result of the transaction and if the credit account is ineligible for a credit limit increase. In other embodiments, however, the terms and/or conditions of the credit account are such that the credit limit may be exceeded as a result of a transaction, regardless of whether the credit account is eligible for a credit limit increase. For example, in some embodiments, a financial institution that maintains the credit account may allow the credit account to go over limit by providing the credit account with additional credit so that the transaction can be completed. Such transactions are sometimes referred to herein as “over limit transactions,” and the act of a credit limit being exceeded is sometimes referred to herein as “going over limit.” In some embodiments, the financial institution that provides the additional credit may assess an over limit fee to the credit account (and/or the holder of the credit account) in exchange for providing the additional credit. Further, in some embodiments, the financial institution may provide the additional credit as part of an “over limit service.”

Of course, it will be understood that the credit limit increase referred to in block 140 may be different than allowing the credit account to go over limit. For example, in some embodiments, the apparatus having the process flow 100 is configured to increase the credit limit of the credit account by an amount such that the credit account does not actually go over limit as a result of the transaction. Additionally or alternatively, in some embodiments, the providing the credit account with additional credit as part of an over limit service may be different than a credit limit increase because the providing the additional credit does not involve increasing the credit limit for the credit account. For example, in some embodiments, the providing the additional credit may be a one-time, temporary, and/or transaction-specific event.

In some embodiments, even if the credit account can go over limit, the apparatus having the process flow 100 is configured to increase the credit limit for the credit account so that the credit account does not have to go over limit. In some of these embodiments, the apparatus may assess the credit account a service fee for increasing the account's credit limit, which, in some embodiments, is lower than an over limit fee typically assessed for going over limit. As such, in some embodiments, the holder may prefer to increase the credit limit for the credit account instead of allowing the credit account to go over limit. In addition to a lower fee, the holder (and/or the financial institution maintaining the credit account and/or apparatus) may prefer that the credit limit be increased instead of the account going over limit for a number of other reasons. For example, in some embodiments, the credit account may not actually go over limit if its credit limit is sufficiently increased before the transaction is authorized; as such, the credit account, financial institution, transaction, and/or service that provides the credit limit increase may not be subject to one or more laws that regulate and/or govern over limit transactions. As another example, in some embodiments, the holder may prefer a credit limit increase to going over limit because going over limit may adversely affect the holder's credit score (e.g., as determined by a credit bureau), whereas a credit limit increase may not (and in some embodiments, may actually improve the holder's credit score).

The transaction information referred to in block 110 can be any information that identifies, defines, describes, and/or is otherwise associated with the transaction. Exemplary transaction information includes, but is not limited to, the party(ies) involved in the transaction, the date and/or time of the transaction, the posting date of the transaction, the account(s) involved in the transaction, the transaction amount(s) associated with the transaction, the good(s) and/or service(s) involved in the transaction (e.g., product names, stock keeping unit (SKU) information, universal product code (UPC) information, etc.), a description of the transaction (which, itself, can include any transaction information, e.g., the description may describe the transaction status, the goods and/or services involved in the transaction, etc.), a merchant category code (MCC) associated with a merchant involved in the transaction, the type of the transaction (e.g., purchase, withdrawal, funds transfer), the channel through which the transaction was performed (e.g., ATM, POS device, etc.), and/or the like.

Also regarding block 110, the apparatus having the process flow 100 can be configured to receive the transaction information in any way. For example, in some embodiments, the apparatus is configured to receive an authorization request associated with the transaction, where the authorization request includes the transaction information. In some embodiments, the apparatus is embodied as an authorization apparatus maintained by a financial institution, where the apparatus is configured to consider, approve, and/or decline authorization requests for debit transactions, credit transactions, ATM transactions, POS device transactions, and/or one or more other types of transactions that involve one or more accounts maintained by the financial institution.

In some embodiments, the apparatus having the process flow 100 is configured to receive the transaction information based at least partially on the holder presenting account information (e.g., account number, debit card number, credit card number, credentials, PIN, expiration date of debit card or credit card, card verification value (CVV), name(s) of holder(s) of the account, etc.) at the transaction machine. For example, in some embodiments, the holder presents account information at the transaction machine by swiping a credit card through the POS device. As another example, in some embodiments, the holder presents account information at the transaction machine by inputting account information into the transaction machine via a user interface associated with the transaction machine. As still another example, in some embodiments, the holder presents account information at the transaction machine by “tapping” an NFC-enabled mobile device at an NFC-enabled transaction machine (e.g., holding the NFC interface of the mobile device within approximately four inches of the NFC interface of the transaction machine, etc.) in order to communicate the account information from the mobile device to the transaction machine.

Additionally or alternatively, the apparatus can be configured to receive the transaction information directly or indirectly from the source of the transaction. For example, in some embodiments, the apparatus is located remotely from the transaction machine but is operatively connected to the transaction machine via a network. As another example, the apparatus may include, be included in, and/or be embodied as a transaction machine. For example, in some embodiments, the apparatus having the process flow 100 includes the transaction machine referred to in block 110. As another example, in some embodiments, the apparatus having the process flow 100 is embodied as a transaction machine separate from, and/or different than, the transaction machine and/or mobile device mentioned in the process flow 100.

Regarding block 120, in some embodiments, the phrase “predetermined portion of the credit limit” refers to a credit limit level or amount that is less than the total credit limit. For example, in some embodiments, the credit limit of the credit account may be $10,000, the predetermined portion of the credit limit may be $9,900, and the transaction amount of the transaction may be $50. In some of these embodiments, the apparatus having the process flow 100 will increase the credit limit for the credit account, even though the credit limit will not be exceeded as a result of the transaction (i.e., $9,900+$50=$9,950<$10,000). However, in other embodiments, the phrase “predetermined portion of the credit limit” does refer to the total credit limit. For example, in some embodiments, the credit limit of the credit account may be $10,000 and the predetermined portion of the credit limit may also be $10,000. In some of these embodiments, the apparatus having the process flow 100 is configured to increase the credit limit only if the total credit limit will be reached and/or exceeded as a result of the transaction.

Further, the phrase “at least a predetermined portion of the credit limit will be used” may refer to only the predetermined portion of the credit limit being used or more than the predetermined portion of the credit limit being used. For example, in some embodiments, where the credit limit is $1,000, where the predetermined portion of the credit limit is $500, and where $600 of the credit limit will be used as a result of the transaction, then it will be understood that at least the predetermined portion of the credit limit will be used (i.e., because $600 is greater than or equal to $500). As another example, in some embodiments, where the credit limit is $1,000, where the predetermined portion of the credit limit is $500, and where $500 of the credit limit will be used as a result of the transaction, then, again, it will be understood that at least the predetermined portion of the credit limit will be used (i.e., because $500 is greater than or equal to $500). However, as another example, in some embodiments, where the credit limit is $1,000, where the predetermined portion of the credit limit is $500, and where $400 of the credit limit will be used as a result of the transaction, then it will be understood that at least the predetermined portion of the credit will not be used (i.e., because $400 is not greater than or equal to $500).

Also, it will be understood that the predetermined portion of the credit limit is “predetermined” because that portion is determined before the apparatus having the process flow 100 makes the credit limit determination represented by block 120. In some embodiments, the predetermined portion of the credit limit is selected by the holder (and/or by the financial institution maintaining the credit account) before the holder engages in the transaction referred to in the process flow 100.

Further regarding block 120, in some embodiments, the apparatus having the process flow 100 is configured to determine that at least the predetermined portion of the credit limit will be used by determining that the transaction amount of the transaction, in combination with the amount of credit available to the account immediately prior to the transaction, meets or exceeds the predetermined portion of the credit limit. In some embodiments, the transaction amount includes the total amount of one or more purchases, draws, fees, charges, balance transfers, debt obligations, and/or other liabilities incurred, or that will be incurred, by the credit account as a result of the transaction.

Also, in some embodiments, the transaction referred to in the process flow 100 refers to a present, initiated, and/or pending transaction. For example, in some embodiments, the apparatus having the process flow 100 is configured to make the credit limit determination (and/or the eligibility determination, the credit limit increase, and/or the sufficiency determination) after the transaction has been initiated at the transaction machine but before the transaction has been authorized and/or completed. In some embodiments, the apparatus having the process flow 100 includes and/or is embodied as a financial transaction processing apparatus that is configured to process financial transactions involving the account and/or the transaction machine referred to in block 110. In some of these embodiments, the apparatus is configured to make the credit limit determination (and/or the eligibility determination, the credit limit increase, and/or the sufficiency determination) at the same time as, and/or nearly the same time as, the apparatus is processing the transaction involving the account.

Additionally or alternatively, in some embodiments, the apparatus includes and/or is embodied as an authorization apparatus (e.g., the authorization apparatus 430 referred to in FIG. 4, etc.) that is configured to consider, authorize, and/or decline authorization requests and/or financial transactions. The apparatus configured to perform the process flow 100 can be configured to make credit limit determinations, eligibility determinations, credit limit increases, and/or sufficiency determinations in real time and/or automatically. In some embodiments, the apparatus is configured to make these determinations and/or the credit limit increase immediately or nearly immediately after the transaction has been initiated at the transaction machine (e.g., upon the swipe of a credit card through a POS device, etc.). However, the apparatus having the process flow 100 can be configured to make these determinations and/or the credit limit increase at any time from when the holder approaches the transaction machine to engage in the transaction to when the holder leaves the transaction machine. Additionally or alternatively, the apparatus can be configured to make these determinations and/or the credit limit increase at any time from when the holder initiates and/or engages in the transaction at the transaction machine to when the transaction is completed.

Regarding block 130, the apparatus can be configured to make the eligibility determination in any way. In some embodiments, the apparatus is configured to make the eligibility determination based at least partially on the credit limit determination. In some embodiments, the apparatus is additionally or alternatively configured to make the eligibility determination based at least partially on a credit score of the holder, the nature of the relationship between the holder and the financial institution that provides the credit limit increase service (e.g., length of time the holder has been an account holder, the number of accounts the holder holds at the financial institution, etc.), the number of over limit transactions the holder and/or credit account has incurred in a predetermined period of time (e.g., the past six months), the annual income of the holder, and/or the like. In some embodiments, the eligibility determination is based at least partially on the transaction information (e.g., based on the transaction amount, the type of transaction, the channel through which the transaction occurred, when the transaction occurred, an MCC associated with the transaction, etc.).

Regarding block 140, the apparatus having the process flow 140 can be configured to increase the credit limit by any amount. For example, in some embodiments, the apparatus having the process flow 100 is configured to increase the credit limit by the difference between the transaction amount and the amount of credit available to the account immediately prior to the transaction. Specifically, in some embodiments, where the amount of credit available to the credit account is $100 and the transaction amount of the transaction is $300, the apparatus may be configured to increase the credit limit by $200, which is just enough to cover the transaction. In still other embodiments, the apparatus is configured to increase the credit limit by some predetermined amount (e.g., $50, $500, etc.) plus the difference between the transaction amount and the amount of credit available to the account immediately prior to the transaction. Accordingly, in such embodiments, the amount of the credit limit increase will be enough to cover the transaction amount of the transaction plus one or more other transactions in which the customer may be involved in later that day, week, month, and/or the like.

In some embodiments, the apparatus having the process flow 100 is configured to increase the credit limit based at least partially on an amount selected by the holder. Specifically, in some embodiments, the apparatus is configured to: (a) prompt the holder, during the transaction (and/or via a mobile device accessible to the holder, via the transaction machine, etc.), to select an amount for a credit limit increase; (b) receive the holder's selected amount for the credit limit increase (e.g., via the mobile device, via the transaction machine, etc.); and/or (c) increase the credit limit based at least partially on the selected amount. In some of these embodiments, the apparatus is configured to increase the credit limit by the holder's selected amount. However, in other embodiments, the amount of the increase is not equal to the holder's selected amount but is based at least partially on, for example, the customer's credit score in addition to the customer's selected amount.

As still another example, in some embodiments, the apparatus having the process flow 100 is configured to increase the credit limit based at least partially on an estimated shortfall for the credit account over a future period of time. Specifically, in some embodiments, the apparatus is configured to: (a) receive a transaction history associated with the credit account; (b) determine, based at least partially on the transaction history, a shortfall for the credit account over a future period of time; and/or (c) increase the credit limit based at least partially on the shortfall. In some of these embodiments, the credit limit is increased by the amount of the shortfall. It will be understood that the transaction history may include information associated with past or previous transactions involving the account (and/or the holder), including, for example, recurring transactions (e.g., monthly bills, car payments, mortgage payments, etc.), non-recurring transactions (e.g., one-time transactions), inflows (e.g., bi-monthly paychecks, social security payments, etc.), outflows, habitual purchases, future funding sources, and/or the like. Also, the apparatus having the process flow 100 can be configured to increase the credit limit based at least partially on the credit limit determination and/or the eligibility determination. Still further, in some embodiments, the credit limit increase may be temporary (e.g., where the credit limit is reduced back to the original level in the next statement cycle, etc.) or permanent (e.g., where the credit limit is maintained at the increased level for the next one or more statement cycles, etc.).

Regarding block 150, the apparatus can be configured to make the sufficiency determination in any way. In some embodiments, the apparatus is configured to make the sufficiency determination based at least partially on the apparatus increasing the credit limit. Regarding block 160, the apparatus can be configured to authorize the transaction in any way. For example, in some embodiments, the apparatus is configured to send, to the transaction machine referred to in the process flow 100, one or more instructions to complete (and/or for completing) the transaction. In some embodiments, the apparatus is configured to authorize the transaction by approving an authorization request associated with the transaction. In some embodiments, the authorization request approved by the apparatus having the process flow 100 was included in the transaction information referred to in block 110. In some embodiments, where the transaction machine referred to in block 110 is the apparatus having the process flow 100, the transaction machine authorizes and/or completes the transaction by performing one or more meaningful actions relevant to the transaction, such as, for example, dispensing cash, accepting a purchase transaction, accepting a check deposit, printing a receipt and/or statement, loading a prepaid storage card, transferring funds, and/or the like. In some embodiments, these one or more actions constitute the exchange central to the transaction, define the transaction, are desired by the holder to be performed, and/or were the reason the holder arrived at the transaction machine in the first place. Also, in some embodiments, the apparatus having the process flow 100 is configured to authorize the transaction based at least partially on the credit limit determination, the eligibility determination, the credit limit increase, and/or the sufficiency determination. In some embodiments, the apparatus having the process flow 100 is configured to increase the credit limit, make the sufficiency determination, and/or authorize the transaction, all at or about the same time.

In accordance with some embodiments, the apparatus configured to perform the process flow 100 is configured to perform the portions of the process flow 100 represented by blocks 110-160 at some point after the holder approaches the transaction machine for the transaction and before the holder leaves the transaction machine. In some embodiments, this means that the apparatus is configured to perform the one or more portions of the process flow 100 (e.g., receive the transaction information, make the credit limit determination, make eligibility determination, increase the credit limit, make the sufficiency determination, authorize the transaction, etc.) during the transaction involving the transaction machine and the holder and/or while the holder is still at the transaction machine.

The apparatus configured to perform the process flow 100 can be configured to perform any of the portions of the process flow 100 represented by blocks 110-160 upon or after one or more triggering events (which, in some embodiments, is one or more of the other portions of the process flow 100). As used herein, a “triggering event” refers to an event that automatically (i.e., without human intervention) triggers the execution, performance, and/or implementation of a triggered action, either immediately, nearly immediately, or sometime after (e.g., within minutes, etc.) the occurrence of the triggering event. For example, in some embodiments, the apparatus configured to perform the process flow 100 is configured such that the apparatus making the eligibility determination (the triggering event) automatically and immediately or nearly immediately (e.g., within 3-30 seconds, etc.) triggers the apparatus to increase the credit limit (the triggered action). In some embodiments, the apparatus is additionally or alternatively configured to make the sufficiency determination, authorize the transaction, and/or complete the transaction (triggered actions) automatically and immediately or nearly immediately after increasing the credit limit (triggering event).

In accordance with some embodiments, the apparatus configured to perform the process flow 100 is configured to automatically perform one or more of the portions of the process flow 100 represented by blocks 110-160, whereas in other embodiments, one or more of the portions of the process flow 100 represented by blocks 110-160 require and/or involve human intervention (e.g., a user operating the apparatus configured to perform the process flow 100, etc.). In addition, it will be understood that, in some embodiments, the apparatus configured to perform the process flow 100 (and/or a user thereof) is configured to perform one or more portions (or combinations of portions) of the process flow 100, from start to finish, within moments, seconds, and/or minutes (e.g., within approximately 1-5 minutes from start to finish, etc.). As an example, in some embodiments, the apparatus having the process flow 100 is configured to increase the credit limit, make the sufficiency determination, and/or authorize the transaction within moments, seconds, and/or minutes (e.g., within approximately 1-5 minutes, etc.) of: (a) receiving the transaction information; (b) making the credit limit determination; and/or (c) making the eligibility determination.

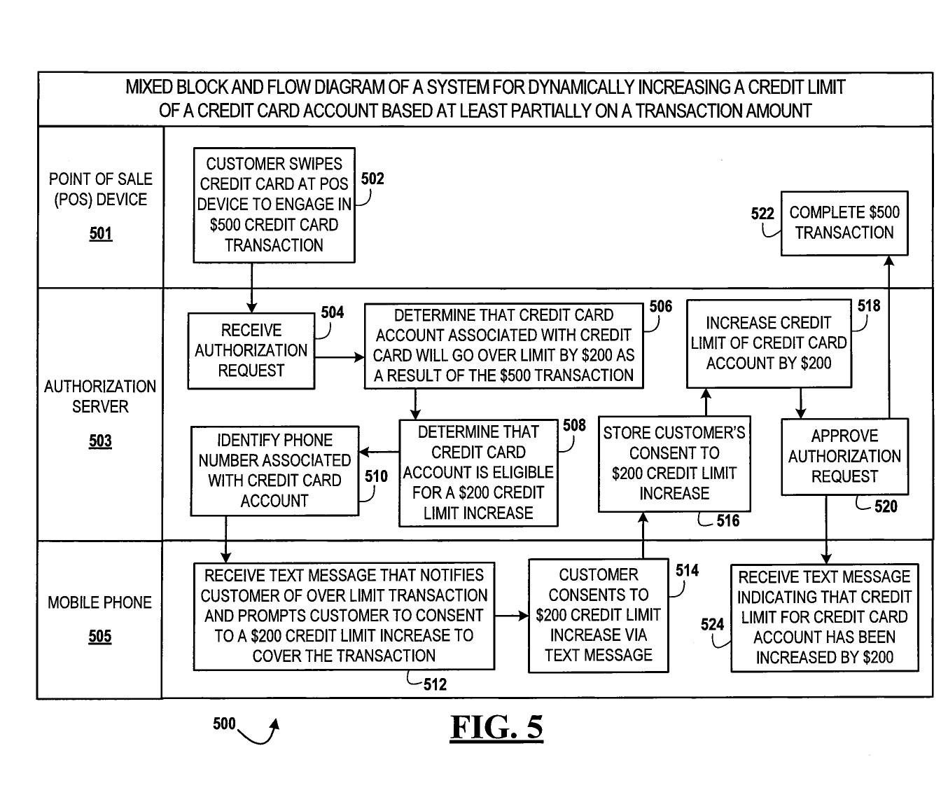

It will be understood that the apparatus having the process flow 100 can be configured to perform one or more portions of any embodiment described and/or contemplated herein, such as, for example, one or more portions of the process flow 200 described herein, one or more portions of the process flow 300 described herein, and/or one or more portions of the process flows described in connection with FIGS. 5 and/or 6. Also, the number, order, and/or content of the portions of the process flow 100 are exemplary and may vary. For example, in some alternative embodiments, the apparatus having the process flow 100 is additionally configured to prompt the holder, during the transaction and/or via the transaction machine and/or via a mobile device accessible to the holder, to consent to the credit limit increase and/or to completing the transaction. As another example, in some alternative embodiments, the apparatus is configured to prompt the holder to select the credit limit increase, either before or during the transaction.

Referring now to FIG. 1A, a general process flow 105 is provided for dynamically increasing a credit limit after authorizing a transaction, in accordance with an embodiment of the present invention. In some embodiments, the process flow 105 is performed by an apparatus (i.e., one or more apparatuses) having hardware and/or software configured to perform one or more portions of the process flow 105. In such embodiments, as represented by block 110 of the process flow 105, the apparatus is configured to receive transaction information associated with a transaction, where the transaction involves a credit account, a transaction machine (e.g., a POS device, ATM, etc.), and a holder of the credit account (and the user of the transaction machine), and where the credit account has a credit limit. As represented by block 120, the apparatus is also configured to determine, based at least partially on the transaction information, that at least a predetermined portion of the credit limit (e.g., 80% of the credit limit, all of the credit limit, etc.) will be used (e.g., met, reached, etc.) as a result of the transaction. In addition, as represented by block 130, the apparatus is further configured to determine that the credit account is eligible for a credit limit increase. As represented by block 145, the apparatus is further configured to determine that the credit limit will be increased so that the credit account will have available credit sufficient to cover the transaction. As represented by block 155, the apparatus is configured to authorize the transaction based at least partially on determining that the credit limit will be increased. Additionally, as represented by block 140 of the process flow 105, the apparatus is configured to increase the credit limit (e.g., after authorizing the transaction).

It will be understood that the process flow 105 represents an alternative embodiment of the process flow 100. The process flow 105 is similar to the process flow 100 except that, for example, the apparatus having the process flow 105 authorizes the transaction before increasing the credit limit, whereas the apparatus having the process flow 100 authorizes the transaction after (or at the same time as) increasing the credit limit. Where the two process flows are similar, the description of the similar portions in connection with FIG. 1 may also apply to the description of those portions in FIG. 1A.

Regarding block 145, the apparatus having the process flow 105 can be configured to make the determination based at least partially on the eligibility determination and/or for the same reasons involved in making the eligibility determination. Regarding blocks 155 and 140 of the process flow 105, the apparatus can be configured to increase the credit limit at any time after authorizing the transaction. In some embodiments, the transaction is authorized at 3:00 pm on a Tuesday and the credit limit is increased at the end of day (e.g., 5:00 pm, 11:59 pm) on that same day. In other embodiments, the credit limit is increased several days after the transaction is authorized. In still other embodiments, the apparatus is configured to increase the credit limit shortly after authorizing the transaction (e.g., within moments, seconds, or minutes after authorizing the transaction, etc.).

Of course, it will be understood that the embodiment illustrated in FIG. 1A is merely exemplary and that other embodiments may vary without departing from the scope and spirit of the present invention. For example, in some alternative embodiments, the apparatus having the process flow 105 is additionally configured to prompt the holder, during the transaction and/or via the transaction machine and/or via a mobile device accessible to the holder, to consent to the credit limit increase and/or to completing the transaction. As another example, in some alternative embodiments, the apparatus is configured to prompt the holder to select the credit limit increase, either before or during the transaction.

In addition, the apparatus having the process flow 105 can be configured to perform one or more portions of the process flow 105 in real time, in substantially real time, and/or at one or more predetermined times. The apparatus having the process flow 105 may be configured to perform any of the portions of the process flow 105 represented by blocks 110-140 upon or after one or more triggering events (which, in some embodiments, is the performance of one or more of the other portions of the process flow 105). In addition, in some embodiments, the apparatus having the process flow 105 (and/or a user thereof) is configured to perform one or more portions (or combinations of portions) of the process flow 105, from start to finish, within moments, seconds, and/or minutes (e.g., within approximately 1-5 minutes, etc.).

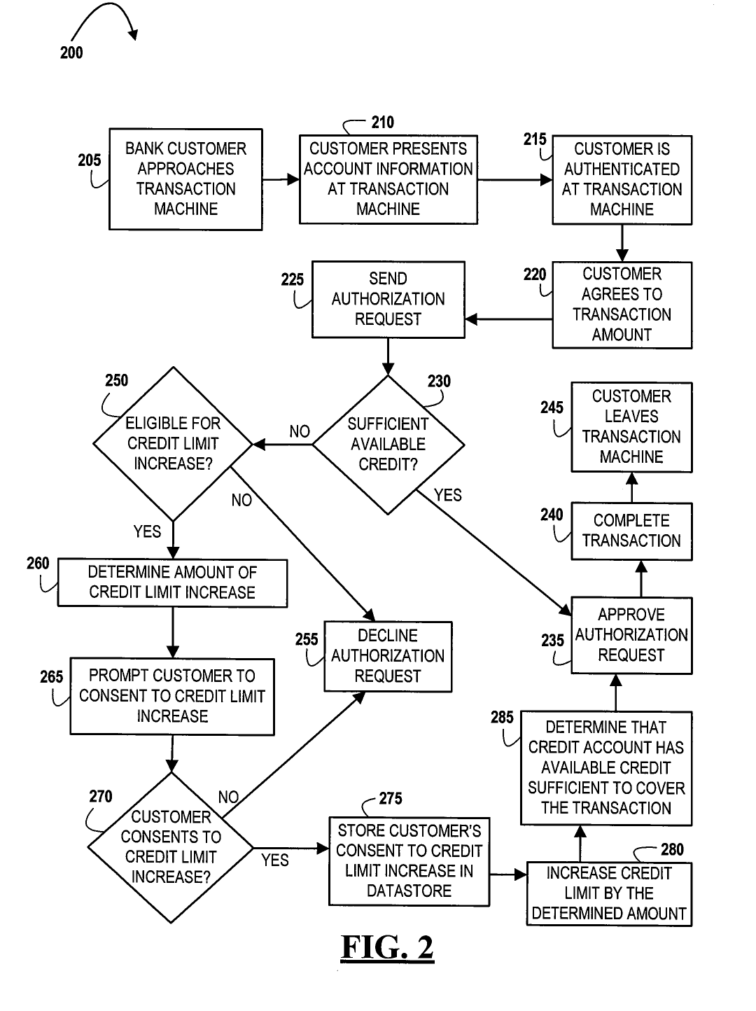

Referring now to FIG. 2, a more-detailed process flow 200 for dynamically increasing a credit limit is provided, in accordance with an embodiment of the present invention. In some embodiments, one or more portions of the process flow 200 are performed by an apparatus having hardware and/or software configured to perform one or more portions of the process flow 200. In some of these embodiments, the apparatus configured to perform the process flow 100 is also configured to perform the process flow 200. As such, it will be understood that the process flow 200 illustrated in FIG. 2 represents an example embodiment of the process flow 100 described in connection with FIG. 1.

Further, the apparatus having the process flow 200 includes, is included in, is embodied as, and/or can be operatively connected to the transaction machine referred to in the process flow 200. In accordance with some embodiments, the apparatus having the process flow 200 is maintained by a bank for the benefit of its customers. Also in accordance with some embodiments, the customer referred to in the process flow 200 is the user of the transaction machine and a customer of the bank. In addition, the credit account referred to in the process flow 200 is a credit account held by the customer and maintained by the bank.

As represented by block 205, the bank customer approaches the transaction machine for the purpose of engaging in a transaction using the transaction machine. As represented by block 210, the customer presents account information at the transaction machine. For example, in some embodiments where the transaction machine is a POS device, the customer may swipe a credit card associated with the credit account through the POS device in order to communicate account information associated with the credit account to the POS device and/or to the apparatus having the process flow 200. As another example, in some embodiments where the transaction machine is a personal computer, the customer may input account information into a web page associated with the transaction that is displayed at the personal computer. After the account information is presented, the transaction machine (and/or the apparatus having the process flow 200) identifies and/or authenticates the customer, as represented by block 215. In some embodiments, the transaction machine authenticates the customer based at least partially on the account information (e.g., userid/password, PIN, credit card, account number, etc.) the customer presents to the transaction machine.

After being authenticated, the customer selects the transaction and/or agrees to the transaction amount, as represented by block 220. Then, as represented by block 225, the transaction machine sends an authorization request to the apparatus having the process flow 200, where the authorization request identifies and/or describes the transaction, the customer, the credit account, and/or the like. Upon receiving the authorization request, the apparatus must determine whether the account has sufficient available credit to cover the transaction, as represented by block 230. In other words, in this example embodiment, the apparatus is configured to determine whether the total credit limit for the credit account will be exceeded as a result of the transaction. For example, in some embodiments, where the credit limit for a credit account is $3,000, the apparatus having the process flow 200 is configured to determine whether the credit account will go over limit as a result of the transaction. Of course, it will be understood that, in alternative embodiments, the apparatus having the process flow 200 can be configured to determine whether a predetermined portion of the credit limit that is less than the total credit limit will be exceeded as a result of the transaction. For example, in one such alternative embodiment, where the credit limit for a credit account is $2,500, and where the predetermined portion of the credit limit is $100 away from the total credit limit, the apparatus is configured to determine whether the available credit for the credit account will be less than $100 after the transaction amount for the transaction is applied to the credit account.

Referring again to block 230, if the apparatus determines that the credit account does have sufficient available credit to cover the transaction, then the apparatus approves the authorization request and/or completes the transaction (and/or instructs the transaction machine to complete the transaction), as represented by blocks 235 and 240. After the transaction is completed at the transaction machine, the customer leaves the transaction machine, as represented by block 245.

However, if the apparatus having the process flow 200 determines that the account does not have sufficient available credit to cover the transaction, then the apparatus is determines whether the credit account (and/or customer) is eligible for a credit limit increase, as represented by block 250. If the customer is not eligible, then the apparatus (and/or the transaction machine) declines the authorization request and/or otherwise declines, cancels, aborts, and/or rejects the transaction, as represented by block 255.

On the other hand, if the apparatus having the process flow 200 determines that the credit account (and/or customer) is eligible for the credit limit increase, then the apparatus is configured to determine the amount of the credit limit increase, as represented by block 260. It will be understood that the apparatus can be configured to determine a credit limit increase of any amount and can make this determination in any way. For example, in some embodiments, the apparatus is configured to determine the amount of the credit limit increase based at least partially on the customer's credit score, length and/or depth of the customer's relationship with the financial institution (e.g., length of time the customer has been an account holder, the number of accounts the customer holds at the financial institution, etc.), the number of over limit transactions the customer and/or credit account has incurred in a predetermined period of time, the annual income of the customer, and/or the like. As another example, in some embodiments, the apparatus having the process flow 200 is configured to determine the amount of the credit limit increase based at least partially on the difference between the transaction amount and the amount of credit available to the account immediately prior to the transaction. For example, in some embodiments, where the amount of available credit to the credit account is $100 and the transaction amount of the transaction is $300, the apparatus may be configured to determine the amount of the credit limit increase as $200, which is just enough to cover the transaction. In still other embodiments, the apparatus is configured to determine the amount to increase the credit limit as some predetermined amount (e.g., $50, $500, etc.) plus the difference between the transaction amount and the amount of credit available to the account immediately prior to the transaction. Accordingly, in such embodiments, the determined amount of the credit limit increase will be enough to cover the transaction amount of the transaction plus one or more other transactions in which the customer may be involved that day.

As yet another example, in some embodiments, the apparatus is configured to determine the amount of the credit limit increase based at least partially on an amount selected by the customer. Specifically, in some embodiments, the apparatus having the process flow 200 is configured to: (a) prompt the customer, during the transaction, to select an amount for a credit limit increase; (b) receive the customer's selected amount for the credit limit increase (e.g., via a mobile device accessible to the customer, via the transaction machine, etc.); and/or (c) determine the amount of the credit limit increase based at least partially on the selected amount. In some of these embodiments, the apparatus is configured to determine the amount of the increase as the customer's selected amount. However, in other embodiments, the amount of the increase is not the customer's selected amount but is based at least partially on the customer's selected amount (as well as, for example, the customer's credit score, relationship with the financial institution, etc.).

As still another example, in some embodiments, the apparatus is configured to determine the amount of the credit limit increase based at least partially on an estimated shortfall for a future period of time. Specifically, in some embodiments, the apparatus is configured to: (a) receive a transaction history associated with the credit account; (b) determine, based at least partially on the transaction history, a shortfall for the credit account over a future period of time; and/or (c) determine the amount of the credit limit increase based at least partially on the shortfall.

After determining the amount of the credit limit increase, the apparatus having the process flow 200 is configured to prompt the customer to consent to the credit limit increase, as represented by block 265. In some embodiments, the apparatus prompts the customer via a mobile device accessible to and/or carried, possessed, owned, and/or controlled by the customer during the transaction. The mobile device can include any number and/or type of mobile device(s). Examples of mobile devices include mobile phones (e.g., feature phones, smart phones, iPhones®, Droids®, etc.), mobile gaming devices (e.g., PlayStation Portable®, etc.), mobile computers (e.g., tablet computers, laptop computers, etc.), personal digital assistants (PDAs), and/or the like. In some embodiments, the mobile device is portable (e.g., not stationary) and/or can be carried and/or worn by and/or on a person.

Further regarding block 265, the prompting the customer may include sending and/or presenting one or more questions, instructions, requests, messages, graphics, sounds, phone calls, notifications, text messages (e.g., SMS messages, MMS messages, EMS messages, etc.), actionable alerts, instant messages, voice messages, voice recordings, interactive voice response (IVR) communications, pages, emails, communications specific to one or more social media networks and/or applications (e.g., Facebook®, Twitter®, MySpace®, etc.), and/or the like. For example, in some embodiments, the apparatus having the process flow 200 sends a text message to the customer's mobile phone, where the text message notifies the holder of the potential over limit transaction and/or prompts the holder to consent to the credit limit increase (e.g., to avoid going over limit) by return text message. As another example, in some embodiments, the apparatus sends a web page to the mobile device that can be rendered at the mobile device to display an input feature (e.g., digital selectable button, link, etc.) that invites the holder to use the input feature to provide the holder's consent. As still another example, in some embodiments where the mobile device includes a speaker, the apparatus having the process flow 200 is configured to send a communication to the mobile device that causes the speaker to output one or more audible instructions that instruct the holder to, for example, depress a physical button and/or speak into a microphone located on and/or near the mobile device in order to provide the holder's consent. As another example, in some embodiments, the apparatus is configured to prompt the holder to consent to the credit limit increase by prompting the holder to re-present account information at the transaction machine. In some of these embodiments, the holder re-presenting the account information at the transaction machine serves to indicate the holder's consent to the credit limit increase.

In some embodiments, the holder requests the prompting, but in other embodiments, the holder does not. In other words, the prompting may include one or more “push” and/or “pull” communications delivered to the mobile device. Also, in some embodiments, the apparatus having the process flow 100 is configured to communicate with the holder, via the mobile device, by using pre-recorded and/or dynamically generated video and/or audio (e.g., which may include one or more menu options, etc.) in order to further communicate with the holder and/or direct the holder how to proceed.

In some embodiments, the prompting the holder includes presenting information to the holder that describes, defines, identifies, and/or is otherwise associated with the over limit determination referred to in block 230. For example, in some embodiments, the apparatus is configured send, to the user interface associated with the customer's mobile device, information that notifies the customer that the transaction, if completed, will result in the credit account going over limit. As another example, in some embodiments, the information notifies the customer that one or more service fees may be assessed (e.g., to the customer, the credit account, etc.) if credit limit is increased in order to complete the transaction. As another example, in some embodiments, the information identifies the amount of the transaction, the available credit for the credit account, the over limit amount, the amount of the service fee(s) associated with increasing the credit limit, and/or the like. In some embodiments, this information may be presented to the customer at the same time as the apparatus prompts the customer to consent to the credit limit increase, but in other embodiments, the information is presented in a separate and/or different communication.

In some embodiments, the mobile device through which the customer is prompted is also a transaction machine, such as, for example, where the mobile device is a smart phone capable of initiating, performing, completing, and/or otherwise facilitating financial transactions. In some embodiments, the mobile device includes and/or is embodied as the transaction machine referred to in block 205, and/or vice versa. For example, in some embodiments, the mobile device is a smart phone (e.g., iPhone®, etc.) that is configured to perform the transaction referred to in process flow 200 (e.g., purchase transaction using the Internet, etc.) and prompt the customer as represented by block 265 (e.g., via the touchscreen display of the iPhone®, etc.). However, in other embodiments, the transaction machine referred to in block 205 is different and/or separate from the mobile device through which the customer is prompted. For example, in some embodiments, the transaction machine referred to in block 205 is a POS device maintained by a merchant, and the mobile device is a smart phone carried by the customer while the customer initiates and/or performs the transaction at the POS device.

Still referring to block 265, in some embodiments, the apparatus is configured to prompt the customer to consent to the credit limit increase via the transaction machine referred to in block 205 (and not via a mobile device). For example, in some embodiments, the transaction machine referred to in block 205 is a POS device maintained by a merchant, and the apparatus having the process flow 200 is configured to send a message to the POS device during the transaction, where the message prompts the customer to consent to the credit limit increase (e.g., via a user interface housed in the POS device).

The phrase “consent to the credit limit increase,” as used herein, is meant to be understood in its broadest sense. For example, in some embodiments, that phrase means consent to: (a) the bank increasing the credit limit; (b) incurring a service fee for the bank increasing the credit limit; (c) one or more terms of a credit service associated with the credit limit increase; (d) using the credit service for this transaction (i.e., the transaction referred to in the process flow 200); and/or (e) completing the transaction. Thus, in some embodiments, the holder consenting to the credit limit increase serves to indicate that the holder consents to the bank increasing the credit limit, to incurring a service fee as a result of increasing the credit limit, and/or to completing the transaction.

After the customer has been prompted, the apparatus is configured to determine whether the customer has consented to the credit limit increase, as represented by block 270. It will be understood that the customer may consent to the credit limit increase in any way. In some embodiments, the customer consents to the credit limit increase via a mobile device accessible to and/or carried, possessed, owned, and/or controlled by the customer during the transaction. For example, the holder may consent to the overage by using one or more input features (e.g., physical and/or digital buttons, microphones, etc.) provided by the mobile device and/or by a mobile banking application that executes on the mobile device. As another example, in some embodiments, the customer consents to the credit limit increase by sending an SMS message (e.g., where the SMS message includes the term “Yes” and/or “Consent,” etc.) from the mobile device to the apparatus having the process flow 200. In other embodiments, however, the holder may consent to the credit limit increase via the transaction machine referred to in the process flow 200. For example, in some embodiments, after being prompted to consent to the credit limit increase via the mobile device, the customer consents to the credit limit increase by using one or more hardware and/or software input features provided by the transaction machine and/or by an application executing on the transaction machine. Accordingly, it will be understood that the customer may be prompted to consent to the credit limit increase via a first channel (e.g., a mobile device, etc.) and then provide his consent to the credit limit increase via a second channel (e.g., the transaction machine, etc.).

As another example, in some embodiments, the customer consents to the credit limit increase by presenting (or re-presenting) account information to the transaction machine after being prompted to consent to the credit limit increase. In such embodiments, the holder presenting or re-presenting the account information serves to indicate the customer's consent to the credit limit increase. For example, in some embodiments where the transaction machine is a POS device, the apparatus having the process flow 200 is configured to prompt the customer to consent to the credit limit increase by re-swiping a credit card through the POS device. If the holder then re-swipes the credit card through the POS device, then the apparatus determines that the holder has consented to the credit limit increase.

In some embodiments, the apparatus prompts the holder to re-swipe the credit card by declining the transaction and/or an authorization request associated with the transaction; in response to the declined transaction and/or request, the customer knows to re-swipe the credit card to consent to the credit limit increase and/or complete the transaction. In still other embodiments, the customer may consent to the credit limit increase via a mobile device or transaction machine, but the customer must still re-swipe the credit card in order to complete the transaction after the credit limit is increased. Also, it will be understood that, in some embodiments, by consenting to the credit limit increase, the holder also consents, either explicitly or implicitly, to one or more terms of a credit service, to incurring a service fee associated with the credit limit increase, to completing the transaction after increasing the credit limit, and/or the like.

If the customer indicates that he does not consent to the credit limit increase (or if the apparatus does not receive a response from the customer within a predetermined period of time (e.g., two minutes)), then the apparatus is configured to decline the authorization request, as represented by block 255. However, if the customer does consent to the credit limit increase, then the apparatus is configured to store the customer's consent in a datastore (e.g., computer-readable memory, etc.), as represented by block 275. In addition, the apparatus also increases the credit limit for the credit account, as represented by block 280. Thereafter, the apparatus determines that the credit account has sufficient available credit to cover the transaction, as represented by block 285. As a result, the apparatus approves the authorization request and otherwise completes the transaction, as represented by blocks 235-240. Again, once the transaction is completed, the customer leaves the transaction machine, as represented by block 245.

Of course, it will be understood that the embodiment illustrated in FIG. 2 is merely exemplary and that other embodiments may vary without departing from the scope and spirit of the present invention. For example, although the apparatus having the process flow 200 is configured to approve the authorization request after increasing the credit limit, it will be understood that, in some alternative embodiments, the apparatus is configured to: (a) determine that the credit limit will be increased; (b) approve the authorization request based at least partially on determining that the credit limit will be increased; and (c) increase the credit limit after approving the authorization request. As another example, in some alternative embodiments, the apparatus having the process flow 200 is additionally configured to prompt the customer (e.g., via a mobile device accessible to the holder, via the transaction machine, etc.) to consent to completing the transaction. As another example, in some alternative embodiments, the apparatus is configured to send a confirmation message to the customer that confirms the customer's consent to the credit limit increase.

In addition, the apparatus having the process flow 200 can be configured to perform one or more portions of the process flow 200 in real time, in substantially real time, and/or at one or more predetermined times. The apparatus having the process flow 200 may be configured to perform any of the portions of the process flow 200 represented by blocks 205-285 upon or after one or more triggering events (which, in some embodiments, is the performance of one or more of the other portions of the process flow 200). In addition, in some embodiments, the apparatus having the process flow 200 (and/or a user thereof) is configured to perform one or more portions (or combinations of portions) of the process flow 200, from start to finish, within moments, seconds, and/or minutes (e.g., within approximately 1-10 minutes, etc.). For example, in some embodiments, the apparatus is configured to prompt the customer to consent to the credit limit increase within approximately thirty seconds of the apparatus determining that the account does not have sufficient available credit.

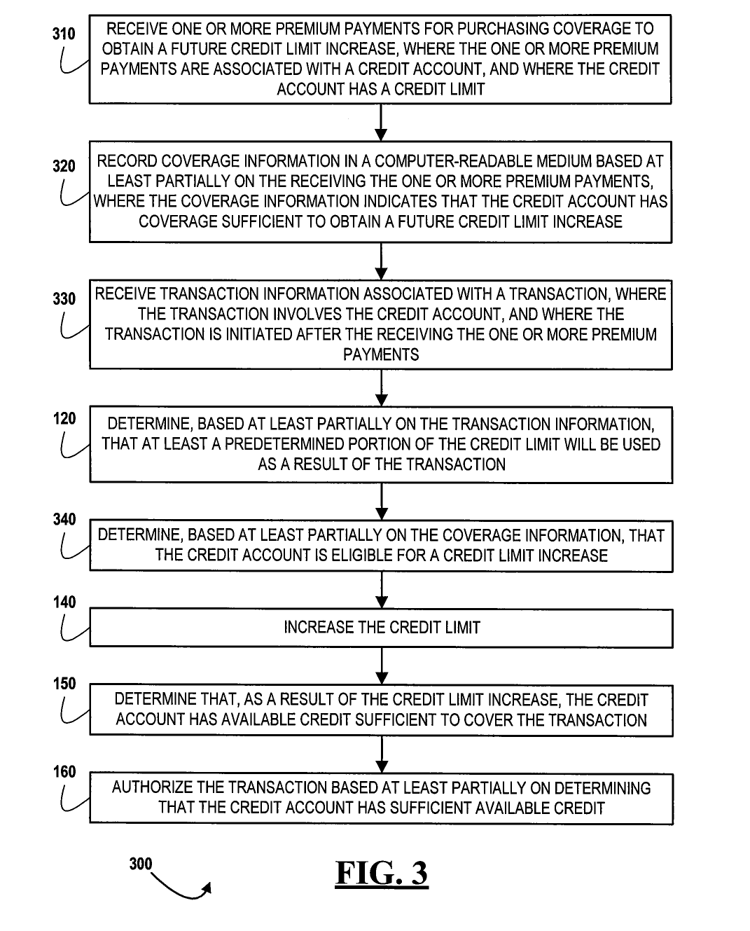

Referring now to FIG. 3, a general process flow 300 is provided for dynamically increasing a credit limit based at partially on coverage provided through an insurance product, in accordance with an embodiment of the present invention. In some embodiments, the process flow 300 is performed by an apparatus (i.e., one or more apparatuses) having hardware and/or software configured to perform one or more portions of the process flow 300. In some of these embodiments, the apparatus configured to perform the process flow 100 is also configured to perform the process flow 300. As such, it will be understood that the process flow 300 illustrated in FIG. 3 represents an example embodiment of the process flow 100 described in connection with FIG. 1. Where the two process flows are similar, the description of the portions in connection with FIG. 1 that are similar may also apply to the description of those portions in FIG. 3.

As represented by block 310, the apparatus is configured to receive one or more premium payments for purchasing coverage to obtain a future credit limit increase, where the one or more premium payments are associated with a credit account, and where the credit account has a credit limit. As represented by block 320, the apparatus is also configured to record coverage information in a computer-readable storage medium (e.g., memory device, datastore, etc.) based at least partially on receiving the one or more premium payments, where the coverage information indicates that the credit account has coverage sufficient to obtain a future credit limit increase. In addition, as represented by block 330, the apparatus is further configured to receive transaction information, where the transaction involves the credit account, and where the transaction is initiated after the receiving the one or more premium payments. Further, as represented by block 120 of the process flow 300, the apparatus is configured to determine, based at least partially on the transaction information, that at least a predetermined portion of the credit limit will be used as a result of the transaction. As represented by block 340, the apparatus is further configured to determine, based at least partially on the coverage information, that the credit account is eligible for a credit limit increase (e.g., because the credit account has coverage sufficient to obtain the credit limit increase, etc.). As represented by block 140 of the process flow 300, the apparatus is further configured to increase the credit limit. As represented by block 150 of the process flow 300, the apparatus is configured to determine that, as a result of the credit limit increase, the credit account has available credit sufficient to cover the transaction. Additionally, as represented by block 160 of the process flow 300, the apparatus is configured to authorize the transaction based at least partially on determining that the credit account has sufficient available credit.

It will be understood that the process flow 300 represents an alternative embodiment of the process flow 100. Indeed, the process flow 300 is similar to the process flow 100 except that, for example, the apparatus having the process flow 300 determines that the account is eligible for the credit limit increase based at least partially on the coverage information. Where the two process flows are similar, the description of the similar portions in connection with FIG. 1 may also apply to the description of those portions in FIG. 3.

In some embodiments, the coverage referred to in block 310 is similar to insurance coverage. For example, in some embodiments, the coverage includes a predetermined coverage period for obtaining the credit limit increase. In such embodiments, the apparatus may be configured to determine that the account has coverage sufficient for a credit limit increase by determining that the transaction occurs during the predetermined coverage period. As another example, in some embodiments, the coverage is sufficient to obtain a predetermined number of future credit limit increases. In such embodiments, the apparatus having the process flow 300 may be configured to determine that the account has coverage sufficient to obtain a credit limit increase by determining that the credit limit increase referred to in block 140 is within the predetermined number. Also, it will be understood that, in some embodiments, the account has coverage to obtain a credit limit increase because the holder of the account has coverage to obtain the credit limit increase. In other words, in some embodiments, the account holder may have coverage that extends to one or more other accounts held by the account holder. However, in other embodiments, the coverage referred to in block 310 is uniquely associated with the account referred to in block 310. Also, in some embodiments, the “future credit limit increase” mentioned in block 310 is the credit limit increase referred to in block 140 of the process flow 300.

Of course, it will be understood that the embodiment illustrated in FIG. 3 is merely exemplary and that other embodiments may vary without departing from the scope and spirit of the present invention. For example, in some alternative embodiments, the apparatus having the process flow 300 is additionally configured to prompt the holder, during the transaction and/or via the transaction machine and/or via a mobile device accessible to the holder, to consent to the credit limit increase and/or to completing the transaction. As another example, in some alternative embodiments, the apparatus is configured to prompt the holder to select the credit limit increase, either before or during the transaction.

In addition, the apparatus having the process flow 300 can be configured to perform one or more portions of the process flow 300 in real time, in substantially real time, and/or at one or more predetermined times. The apparatus having the process flow 300 may be configured to perform any of the portions of the process flow 300 represented by blocks 310-160 upon or after one or more triggering events (which, in some embodiments, is the performance of one or more of the other portions of the process flow 300). In addition, in some embodiments, the apparatus having the process flow 300 (and/or a user thereof) is configured to perform one or more portions (or combinations of portions) of the process flow 300, from start to finish, within moments, seconds, and/or minutes (e.g., within approximately 1-5 minutes, etc.).

Referring now to FIG. 4, a system 400 is illustrated for dynamically increasing a credit limit and/or providing one or more other credit services, in accordance with an embodiment of the present invention. As illustrated, the system 400 includes a network 410, a transaction machine 420, an authorization apparatus 430, and a mobile device 440. FIG. 4 also shows an account holder 402 and a profile 408 for a credit account (e.g., credit card account, LOC account, HELOC account, etc.) that is stored in the account datastore 438 of the authorization apparatus 430. As shown, the account profile 408 includes account information 408A, transaction history 408B, credit limit information 408C, and coverage information 408D. Also as shown, the credit account that is associated with the profile 408 is held by the account holder 402 and may be accessed via online banking, mobile banking, and/or text banking As shown, the holder 402 has access to the mobile device 440 and the transaction machine 420. In accordance with some embodiments, the transaction machine 420 and the authorization apparatus 430 are each maintained by the same financial institution. For example, in some embodiments, the holder 402 is a customer of the financial institution, the authorization apparatus 430 is embodied as an ATM transaction server maintained by the financial institution, and the transaction machine 420 is embodied as an ATM maintained by the financial institution. However, in other embodiments, the transaction machine 420 and the authorization apparatus 430 are maintained by separate entities. For example, in some embodiments, the transaction machine 420 is embodied as a POS device maintained by a merchant, and the authorization apparatus 430 is embodied as an authorization server maintained by a financial institution. In accordance with some embodiments, the mobile device 440 is carried, owned, possessed, and/or owned by the holder 402, either during a transaction or otherwise.

As shown in FIG. 4, the transaction machine 420, the authorization apparatus 430, and the mobile device 440 are each operatively and selectively connected to the network 410, which may include one or more separate networks. The network 410 may include one or more payment networks (e.g., interbank networks, Visa's® payment network VisaNet®, MasterCard's® payment network BankNet®, any wireline and/or wireless network over which payment information is sent, etc.), telephone networks (e.g., cellular networks, CDMA networks, any wireline and/or wireless network over which communications to telephones and/or mobile phones are sent, etc.), local area networks (LANs), wide area networks (WANs), global area networks (GANs) (e.g., the Internet, etc.), and/or one or more other telecommunications networks. For example, in some embodiments, the network 410 includes a telephone network (e.g., for communicating with the mobile device 440, etc.) and a payment network (e.g., for communicating with the transaction machine 420, etc.). It will also be understood that the network 410 may be secure and/or unsecure and may also include wireless and/or wireline technology.

The transaction machine 420 can be configured to perform any one or more of the functions of any transaction machine and/or apparatus described and/or contemplated herein. It will also be understood that the transaction machine 420 can include and/or be embodied as any transaction machine and/or apparatus described and/or contemplated herein. For example, in some embodiments, the transaction machine 420 includes and/or is embodied as an ATM, a POS device, a self-checkout machine, a vending machine, a ticketing kiosk, a personal computer, a gaming device, a mobile phone, and/or the like. In some embodiments, the transaction machine 420 is configured to initiate, perform, complete, and/or otherwise facilitate one or more financial and/or non-financial transactions, including, for example, purchasing, renting, selling, and/or leasing goods and/or services (e.g., groceries, stamps, tickets, gift certificates, DVDs, etc.); withdrawing cash; making deposits (e.g., cash, checks, etc.); making payments (e.g., paying telephone bills, sending remittances, etc.); checking account balances; navigating the Internet; and/or the like.

In some embodiments, the transaction machine 420 (and/or one or more other portions of the system 400) requires its users to authenticate themselves to the transaction machine 420 before the transaction machine 420 will initiate, perform, complete, and/or facilitate a transaction. For example, in some embodiments, the transaction machine 420 (and/or the transaction application 427) is configured to authenticate a transaction machine user based at least partially on an ATM/debit/credit card, loyalty/rewards/club card, smart card, token (e.g., USB token, etc.), username/password, personal identification number (PIN), biometric information, and/or one or more other credentials that the user presents to the transaction machine 420. Additionally or alternatively, in some embodiments, the transaction machine 420 is configured to authenticate a user by using one-, two-, or multi-factor authentication. For example, in some embodiments, the transaction machine 420 requires two-factor authentication, such that the holder 402 must provide a valid credit card and enter the correct PIN associated with the credit card in order to authenticate the holder 402 to the transaction machine 420.

As illustrated in FIG. 4, in accordance with some embodiments of the present invention, the transaction machine 420 includes a communication interface 422, a processor 424, a memory 426 having a transaction application 427 stored therein, and a user interface 429. In such embodiments, the processor 424 is operatively and selectively connected to the communication interface 422, the user interface 429, and the memory 426.

Each communication interface described herein, including the communication interface 422, generally includes hardware, and, in some instances, software, that enables a portion of the system 400, such as the transaction machine 420, to send, receive, and/or otherwise communicate information to and/or from the communication interface of one or more other portions of the system 400. For example, the communication interface 422 of the transaction machine 420 may include a modem, network interface controller (NIC), NFC interface, network adapter, network interface card, and/or some other electronic communication device that operatively connects the transaction machine 420 to another portion of the system 300, such as, for example, the authorization apparatus 430.

Each processor described herein, including the processor 424, generally includes circuitry for implementing the audio, visual, and/or logic functions of that portion of the system 400. For example, the processor may include a digital signal processor device, a microprocessor device, and various analog-to-digital converters, digital-to-analog converters, and other support circuits. Control and signal processing functions of the system in which the processor resides may be allocated between these devices according to their respective capabilities. The processor may also include functionality to operate one or more software programs based at least partially on computer-executable program code portions thereof, which may be stored, for example, in a memory device, such as in the transaction application 427 of the memory 426 of the transaction machine 420.

Each memory device described herein, including the memory 426 for storing the transaction application 427 and other information, may include any computer-readable medium. For example, the memory may include volatile memory, such as volatile random access memory (RAM) having a cache area for the temporary storage of data. Memory may also include non-volatile memory, which may be embedded and/or may be removable. The non-volatile memory may additionally or alternatively include an EEPROM, flash memory, and/or the like. The memory may store any one or more of portions of information used by the apparatus in which it resides to implement the functions of that apparatus.

As shown in FIG. 4, the memory 426 includes the transaction application 427. It will be understood that the transaction application 427 can be operable (e.g., usable, executable, etc.) to initiate, perform, complete, and/or facilitate one or more portions of any embodiment described and/or contemplated herein, such as, for example, one or more portions of the process flows 100, 105, 200, and/or 300 described herein and/or one or more portions of the process flows described in connection with FIGS. 5 and/or 6. For example, in some embodiments, the transaction application 427 is operable to receive transaction information associated with a transaction. As another example, in some embodiments, the transaction application 427 is operable to determine that at least a predetermined portion of a credit limit will be used as a result of a transaction. As still another example, in some embodiments, the transaction application 427 is operable to determine that a credit account is eligible for a credit limit increase (e.g., based at least partially on account information 408A, transaction history 408B, credit limit information 408C, and/or coverage information 408D, etc.). As another example, in some embodiments, the transaction application 427 is operable to increase the credit limit of a credit account. As still another example, in some embodiments, the transaction application 427 is operable to determine that a credit account has available credit sufficient to cover a transaction. As yet another example, in some embodiments, the transaction application 427 is operable to authorize a transaction.

As still another example, in some embodiments, the transaction application 427 is operable to: (a) prompt an account holder (e.g., the holder 402), via the user interface 429 (and/or via the user interface 449 of the mobile device 440), to consent to a credit limit increase; and; and (b) receive, via the user interface 429 (and/or via the user interface 449) the holder's consent to the credit limit increase. In such embodiments, the transaction application 427 can be operable to increase the credit limit for the holder's account based at least partially on receiving the holder's consent. As still another example, in some embodiments, the transaction application 427 is operable to: (a) receive a notification that indicates that an account holder (e.g., the holder 402) does not consent to a credit limit increase; and (b) decline the second transaction based at least partially on receiving the notification.

Additionally or alternatively, in some embodiments, the transaction application 427 is operable to: (a) receive a transaction history (e.g., transaction history 408B) associated with a credit account; and (b) determine, based at least partially on the transaction history, a shortfall for the credit account over a future period of time. In such embodiments, the transaction application 427 can be operable to increase a credit limit for the credit account based at least partially on the shortfall. As still another example, in some embodiments, the transaction application 427 is operable to: (a) prompt a holder (e.g., the holder 402) (e.g., via the user interface 429 and/or user interface 449) to select an amount for a credit limit increase; and (b) receive (e.g., via the user interface 429 and/or user interface 449) the holder's selected amount for the credit limit increase. In such embodiments, the transaction application 427 can be operable to increase the credit limit based at least partially on the selected amount. As yet another example, in some embodiments, the transaction application 427 is operable to complete one or more transactions at the transaction machine 420 (e.g., complete a purchase transaction, dispense cash, accept a check for deposit, etc.).

In some embodiments, where the transaction machine 420 includes and/or is embodied as an ATM, the transaction application 427 is configured to execute on the ATM in order to initiate, perform, complete, and/or facilitate, for example, one or more cash withdrawals, deposits, and/or the like. In other embodiments, where the transaction machine 420 includes and/or is embodied as a POS device, the transaction application 427 is configured to execute on the POS device in order to initiate, perform, complete, and/or facilitate, for example, one or more debit card and/or credit card transactions. In still other embodiments, where the transaction machine 420 includes and/or is embodied as a personal computer, the transaction application 427 is configured to execute on the personal computer, and, in some embodiments, the transaction application 427 is embodied as a web browser (e.g., for navigating the Internet, etc.) that is operable to initiate, perform, complete, and/or otherwise facilitate one or more financial and/or non-financial transactions.

In some embodiments, the transaction application 427 is operable to enable the holder 402 and/or transaction machine 420 to communicate with one or more other portions of the system 400, and/or vice versa. In some embodiments, the transaction application 427 is additionally or alternatively operable to initiate, perform, complete, and/or otherwise facilitate one or more financial and/or non-financial transactions. In some embodiments, the transaction application 427 includes one or more computer-executable program code portions for causing and/or instructing the processor 424 to perform one or more of the functions of the transaction application 427 and/or transaction machine 420 described and/or contemplated herein. In some embodiments, the transaction application 427 includes and/or uses one or more network and/or system communication protocols.

As shown in FIG. 4, the transaction machine 420 also includes the user interface 429. It will be understood that the user interface 429 (and any other user interface described and/or contemplated herein) can include and/or be embodied as one or more user interfaces. It will also be understood that, in some embodiments, the user interface 429 includes one or more user output devices for presenting information and/or one or more items to the transaction machine user (e.g., the holder 402, etc.), such as, for example, one or more displays, speakers, receipt printers, dispensers (e.g., cash dispensers, ticket dispensers, merchandise dispensers, etc.), and/or the like. In some embodiments, the user interface 429 additionally or alternatively includes one or more user input devices, such as, for example, one or more buttons, keys, dials, levers, directional pads, joysticks, keyboards, mouses, accelerometers, controllers, microphones, touchpads, touchscreens, haptic interfaces, styluses, scanners, biometric readers, motion detectors, cameras, card readers (e.g., for reading the magnetic strip on magnetic cards such as ATM, debit, credit, and/or bank cards, etc.), deposit mechanisms (e.g., for depositing checks and/or cash, etc.), and/or the like for receiving information from one or more items and/or from the transaction machine user (e.g., the holder 402, etc.). In some embodiments, the user interface 429 and/or the transaction machine 420 includes one or more vaults, security sensors, locks, and/or anything else typically included in and/or near the transaction machine.

FIG. 4 also illustrates an authorization apparatus 430. The authorization apparatus 430 can be configured to perform any one or more of the functions of any apparatus described and/or contemplated herein. It will also be understood that the authorization apparatus 430 can include and/or be embodied as any apparatus described and/or contemplated herein. For example, in some embodiments, the authorization apparatus 430 includes and/or is embodied as one or more servers, engines, mainframes, personal computers, ATMs, network devices, front end systems, back end systems, and/or the like. In some embodiments, the authorization apparatus 430 is configured to initiate, perform, authorize, complete, and/or otherwise facilitate one or more financial and/or non-financial transactions, including, for example, purchasing, renting, selling, and/or leasing goods and/or services (e.g., groceries, stamps, tickets, gift certificates, DVDs, etc.); withdrawing cash; making deposits (e.g., cash, checks, etc.); making payments (e.g., paying telephone bills, sending remittances, etc.); checking account balances; navigating the Internet; and/or the like. In some embodiments, such as the one illustrated in FIG. 3, the authorization apparatus 430 includes a communication interface 432, a processor 434, and a memory 436, which includes an authorization application 437 and an account datastore 438 stored therein. As shown, the communication interface 432 is operatively and selectively connected to the processor 434, which is operatively and selectively connected to the memory 436.

The authorization application 437 can be operable (e.g., usable, executable, etc.) to initiate, perform, complete, and/or facilitate one or more portions of any embodiment described and/or contemplated herein, such as, for example, one or more portions of the process flows 100, 105, 200, and/or 300 described herein and/or one or more portions of the process flows described in connection with FIGS. 5 and/or 6. For example, in some embodiments, the authorization application 437 is operable to receive transaction information associated with a transaction. As another example, in some embodiments, the authorization application 437 is operable to determine that at least a predetermined portion of a credit limit will be used as a result of a transaction. As still another example, in some embodiments, the authorization application 437 is operable to determine that a credit account is eligible for a credit limit increase. As another example, in some embodiments, the authorization application 437 is operable to increase the credit limit of a credit account. As still another example, in some embodiments, the authorization application 437 is operable to determine that a credit account has available credit sufficient to cover a transaction. As yet another example, in some embodiments, the authorization application 437 is operable to authorize a transaction.

As still another example, in some embodiments, the authorization application 437 is operable to: (a) prompt an account holder (e.g., the holder 402), via the user interface 429 of the transaction machine 420 (and/or via the user interface 449 of the mobile device 440), to consent to a credit limit increase; and (b) receive, via the user interface 429 (and/or via the user interface 449) the holder's consent to the credit limit increase. In such embodiments, the authorization application 437 can be operable to increase the credit limit for the holder's account based at least partially on receiving the holder's consent. As still another example, in some embodiments, the authorization application 437 is operable to: (a) receive a notification that indicates that an account holder (e.g., the holder 402) does not consent to a credit limit increase; and (b) decline the second transaction based at least partially on receiving the notification.

Additionally or alternatively, in some embodiments, the authorization application 437 is operable to: (a) receive a transaction history (e.g., transaction history 408B) associated with a credit account; and (b) determine, based at least partially on the transaction history, a shortfall for the credit account over a future period of time. In such embodiments, the authorization application 437 can be operable to increase a credit limit for the credit account based at least partially on the shortfall. As still another example, in some embodiments, the authorization application 437 is operable to: (a) prompt a holder (e.g., the holder 402) (e.g., via the user interface 429 and/or user interface 449) to select an amount for a credit limit increase; and (b) receive (e.g., via the user interface 429 and/or user interface 449) the holder's selected amount for the credit limit increase. In such embodiments, the authorization application 437 can be operable to increase the credit limit based at least partially on the selected amount. As yet another example, in some embodiments, the authorization application 437 is operable to instruct a transaction machine (e.g., the transaction machine 420) to complete one or more transactions at that transaction machine (e.g., complete a purchase transaction, dispense cash, accept a check for deposit, etc.).

In some embodiments, the authorization application 437 is operable to enable the holder 402 and/or authorization apparatus 430 to communicate with one or more other portions of the system 400, and/or vice versa. In some embodiments, the authorization application 437 is additionally or alternatively operable to initiate, perform, authorize, complete, and/or otherwise facilitate one or more financial and/or non-financial transactions. In some embodiments, the authorization application 437 includes one or more computer-executable program code portions for causing and/or instructing the processor 434 to perform one or more of the functions of the authorization application 437 and/or authorization apparatus 430 described and/or contemplated herein. In some embodiments, the authorization application 437 includes and/or uses one or more network and/or system communication protocols.

In addition to the authorization application 437, the memory 436 also includes the account datastore 438. It will be understood that the authorization datastore 438 can be configured to store any type and/or amount of information. As shown, the account datastore 438 stores the account profile 408, which includes credit card account information 408A, one or more transaction histories 408, credit limit information 408C, and coverage information 408D. The account information 408A may include any information associated with the credit card account held by the holder 402, including, for example, information associated with one or more account holders (e.g., holder 402), information associated with one or more account preferences, billing information, the terms and conditions associated with the credit account, and/or the like. The transaction history 408B may include transaction information associated with one or more transactions involving the credit card account (e.g., date/time, description, transaction amount, whether the transaction caused the account to go over limit, merchant category codes, etc.). The credit limit information 408C may include any information associated with the credit limit of the credit account, including, for example, the amount of the credit limit, the amount of the credit limit that has been used (e.g., currently, in previous months, etc.), the number of credit limit increases over a predetermined period of time, and/or the like. The coverage information 408D may include information associated with one or more premium payments, whether the holder 402 currently has coverage sufficient to obtain a credit limit increase, the terms and/or conditions of the coverage, the expiration dates associated with any such coverage, if/when the coverage was used in the past to obtain a credit limit increase, and/or the like.

In addition to the account profile 408, the account datastore 438 may include information associated with one or more account holders (e.g., the holder 402, account holders other than the holder 402), account profiles (i.e., other than the account profile 408), financial accounts (i.e., other than the credit card account held by the holder 402), transaction machine, transaction machine users, mobile devices, financial accounts, credit limits, and/or the like. Also, the account datastore 438 may include any one or more storage devices, including, but not limited to, datastores, databases, and/or any of the other storage devices and/or computer-readable media typically associated with a computer system. It will also be understood that these datastores may store information in any known way, such as, for example, by using one or more computer codes and/or languages, alphanumeric character strings, data sets, figures, tables, charts, links, documents, and/or the like. Further, in some embodiments, the account datastore 438 includes information associated with one or more applications, such as, for example, the authorization application 437 and/or the transaction application 427. In some embodiments, the account datastore 438 provides a real-time or near real-time representation of the information stored therein, so that, for example, when the processor 434 accesses the account datastore 438, the information stored therein is current or nearly current. Although not shown, in some embodiments, the transaction machine 420 may include one or more datastores that are configured to store information associated with that respective machine. It will be understood that those datastores can store information in any known way, can include information associated with anything shown in FIG. 4, and/or can be configured similar to the account datastore 438.

Referring now to FIG. 4A, a block diagram is provided that illustrates the mobile device 440 of FIG. 4 in more detail, in accordance with an embodiment of the invention. In some embodiments, the mobile device 440 is a mobile phone, but in other embodiments, the mobile device 440 can include and/or be embodied as any other mobile device described and/or contemplated herein (e.g., PDA, portable gaming device, etc.). The mobile device 440 generally includes a processor 444 operatively connected to such devices as a memory 446, user interface 449 (i.e., user output devices 449A and user input devices 449B), a communication interface 442, a power source 445, a clock or other timer 443, a camera 441, and a positioning system device 490.

The processor 444 may include the functionality to encode and interleave messages and data prior to modulation and transmission. The processor 444 can additionally include an internal data modem. Further, the processor 444 may include functionality to operate one or more software programs, which may be stored in the memory 446. For example, the processor 444 may be capable of operating a connectivity program, such as a web browser application 448. The web browser application 448 may then allow the mobile device 440 to transmit and receive web content, such as, for example, location-based content and/or other web page content, according to a Wireless Application Protocol (WAP), Hypertext Transfer Protocol (HTTP), and/or the like.

The processor 444 is configured to use the communication interface 442 to communicate with one or more other devices on the network 410. In this regard, the communication interface 442 includes an antenna 476 operatively coupled to a transmitter 474 and a receiver 472 (together a “transceiver”). The processor 444 is configured to provide signals to and receive signals from the transmitter 474 and receiver 472, respectively. The signals may include signaling information in accordance with the air interface standard of the applicable cellular system of the wireless telephone network 410. In this regard, the mobile device 440 may be configured to operate with one or more air interface standards, communication protocols, modulation types, and access types. By way of illustration, the mobile device 440 may be configured to operate in accordance with any of a number of first, second, third, and/or fourth-generation communication protocols and/or the like. For example, the mobile device 440 may be configured to operate in accordance with second-generation (2G) wireless communication protocols IS-136 (time division multiple access (TDMA)), GSM (global system for mobile communication), and/or IS-95 (code division multiple access (CDMA)), or with third-generation (3G) wireless communication protocols, such as Universal Mobile Telecommunications System (UMTS), CDMA2000, wideband CDMA (WCDMA) and/or time division-synchronous CDMA (TD-SCDMA), with fourth-generation (4G) wireless communication protocols, and/or the like. The mobile device 440 may also be configured to operate in accordance with non-cellular communication mechanisms, such as via a wireless local area network (WLAN) or other communication/data networks.

The communication interface 442 may also include a near field communication (NFC) interface 470. As used herein, the phrase “NFC interface” generally refers to hardware and/or software that is configured to contactlessly and/or wirelessly send and/or receive information over relatively short ranges (e.g., within four inches, within three feet, within fifteen feet, etc.). The NFC interface 470 may include a smart card, key card, proximity card, Bluetooth® device, radio frequency identification (RFID) tag and/or reader, transmitter, receiver, and/or the like. In some embodiments, the NFC interface 470 communicates information via radio frequency (RF), infrared (IR), and/or optical transmissions. In some embodiments, the NFC interface 470 is configured to operate as an NFC transmitter and/or as an NFC receiver (e.g., an NFC reader, etc.). In some embodiments, the NFC interface 470 enables the mobile device 440 to operate as a mobile wallet. Also, it will be understood that the NFC interface 470 may be embedded, built, carried, and/or otherwise supported in and/or on the mobile device 440. In some embodiments, the NFC interface 470 is not supported in and/or on the mobile device 440, but the NFC interface 470 is otherwise operatively connected to the mobile device 440 (e.g., where the NFC interface 470 is a peripheral device plugged into the mobile device 440, etc.). Other apparatuses having NFC interfaces mentioned herein may be configured similarly.

In some embodiments, the NFC interface 470 of the mobile device 440 is configured to contactlessly and/or wirelessly communicate information to and/or from a corresponding NFC interface of another apparatus (e.g., the transaction machine 420, etc.). For example, in some embodiments, the mobile device 440 is a mobile phone, the NFC interface 470 is a smart card having account information stored therein, and the transaction machine 420 is a POS device having an NFC reader operatively connected thereto. In such embodiments, when the mobile phone and/or smart card is brought within a relatively short range of the NFC reader, the smart card is configured to wirelessly and/or contactlessly send the account information to the NFC reader in order to, for example, initiate, perform, complete, and/or otherwise facilitate a transaction using the account information.

In addition to the NFC interface 470, the mobile device 440 can have a user interface 449 that is, like other user interfaces described herein, made up of one or more user output devices 449A and/or user input devices 449B. The user output devices 449A include a display 480 (e.g., a liquid crystal display and/or the like) and a speaker 482 and/or other audio device, which are operatively coupled to the processor 444. The user input devices 449B, which allow the mobile device 440 to receive data from a user such as the holder 402, may include any of a number of devices allowing the mobile device 440 to receive data from a user, such as a keypad, keyboard, touch-screen, touchpad, microphone, mouse, joystick, other pointer device, button, soft key, and/or other input device(s). The user interface 449 may also include a camera 441, such as a digital camera.

In some embodiments, the mobile device 440 also includes a positioning system device 490 that can be used to determine the location of the mobile device 440. For example, the positioning system device 490 may include a GPS transceiver. In some embodiments, the positioning system device 490 is at least partially made up of the antenna 476, transmitter 474, and receiver 472 described above. For example, in one embodiment, triangulation of cellular signals may be used to identify the approximate location of the mobile device 440. In other embodiments, the positioning system device 490 includes a proximity sensor and/or transmitter, such as an RFID tag, that can sense or be sensed by devices known to be located proximate a merchant and/or other location to determine that the mobile device 440 is located proximate these known devices.

The mobile device 440 further includes a power source 445, such as a battery, for powering various circuits and other devices that are used to operate the mobile device 440. Embodiments of the mobile device 440 may also include a clock or other timer 443 configured to determine and, in some cases, communicate actual or relative time to the processor 444 or one or more other devices.

The mobile device 440 also includes a memory 446 operatively connected to the processor 444. As used herein, memory includes any computer readable medium (as defined herein) configured to store data, code, and/or other information. The memory 446 may include volatile memory, such as volatile Random Access Memory (RAM) including a cache area for the temporary storage of data. The memory 446 may also include non-volatile memory, which can be embedded and/or may be removable. The non-volatile memory can additionally or alternatively include an electrically erasable programmable read-only memory (EEPROM), flash memory, and/or the like.

The memory 446 can store any of a number of applications which may include computer-executable instructions/code executed by the processor 444 to implement the functions of the mobile device 440 described herein. For example, the memory 446 may include such applications as a web browser application 448 and/or a mobile banking application 447. It will be understood that the web browser application 448 and/or the mobile banking application 447 can be, individually or collectively, operable (e.g., usable, executable, etc.) to initiate, perform, complete, and/or facilitate any one or more portions of the process flows 100, 105, 200, and/or 300 described herein and/or one or more portions of the process flows described in connection with FIGS. 5 and/or 6. For example, in some embodiments, the mobile banking application 447 (and/or the web browser application 448) is operable to receive transaction information associated with a transaction. As another example, in some embodiments, the mobile banking application 447 (and/or the web browser application 448) is operable to determine that at least a predetermined portion of a credit limit will be used as a result of a transaction. As still another example, in some embodiments, the mobile banking application 447 (and/or the web browser application 448) is operable to increase a credit limit of a credit account and/or determine that a credit account (and/or a holder of the account) is eligible for a credit limit increase. As another example, in some embodiments, the mobile banking application 447 (and/or the web browser application 448) is operable to determine that a credit account has available credit sufficient to cover a transaction. Additionally or alternatively, in some embodiments, the mobile banking application 447 (and/or the web browser application 448) is operable to receive one or more messages (e.g., notifications, communications, text message, phone calls, emails, etc.) (e.g., from the transaction machine 420, from the authorization apparatus 430, etc.), where the one or more messages include information associated with a credit account, credit limit, credit limit increase, transaction, potentially going over limit as a result of a transaction. Additionally or alternatively, in some embodiments, the one or more messages serve to prompt the holder 402 (and/or other user of the mobile device 440) to: (a) consent to a credit limit increase; (b) consent to completing a transaction; (c) select an amount for a credit limit increase; and/or (d) present (and/or re-present) account information at a transaction machine (e.g., the transaction machine 420, etc.), which in some embodiments, serves to indicate the holder's consent to the credit limit increase and/or to completing the transaction.

In some embodiments, these applications provide a graphical user interface (GUI) on the display 480 that allows the holder 402 to communicate with the mobile device 440, the transaction machine 420, the authorization apparatus 430, and/or one or more other portions of the system 400. In some embodiments, the holder 402 can use the mobile banking application 447 to access the credit account via an electronic banking service (e.g., mobile banking, text banking, etc.). The memory 446 can also store any type and/or amount information used by the mobile device 440, and/or used by the applications and/or the devices that make up the mobile device 440 and/or that are in communication with the mobile device 440, to implement the functions of the mobile device 440 and/or the other systems described and/or contemplated herein. For example, in some embodiments, the memory 446 stores account information (e.g., routing and/or account numbers, account names, username/passwords, PINS, biometric information, etc.) associated with the holder 402.

The embodiments illustrated in FIGS. 4 and 4A are exemplary and other embodiments may vary. For example, in some embodiments, some or all of the portions of the system 400 are combined into a single portion. Specifically, in some embodiments, the transaction machine 420 and the authorization apparatus 430 are combined into a single transaction and authorization apparatus that is configured to perform all of the same functions of those separate portions as described and/or contemplated herein. Likewise, in some embodiments, some or all of the portions of the system 400 are separated into two or more distinct portions. In addition, the various portions of the system 400 may be maintained by the same or separate parties.

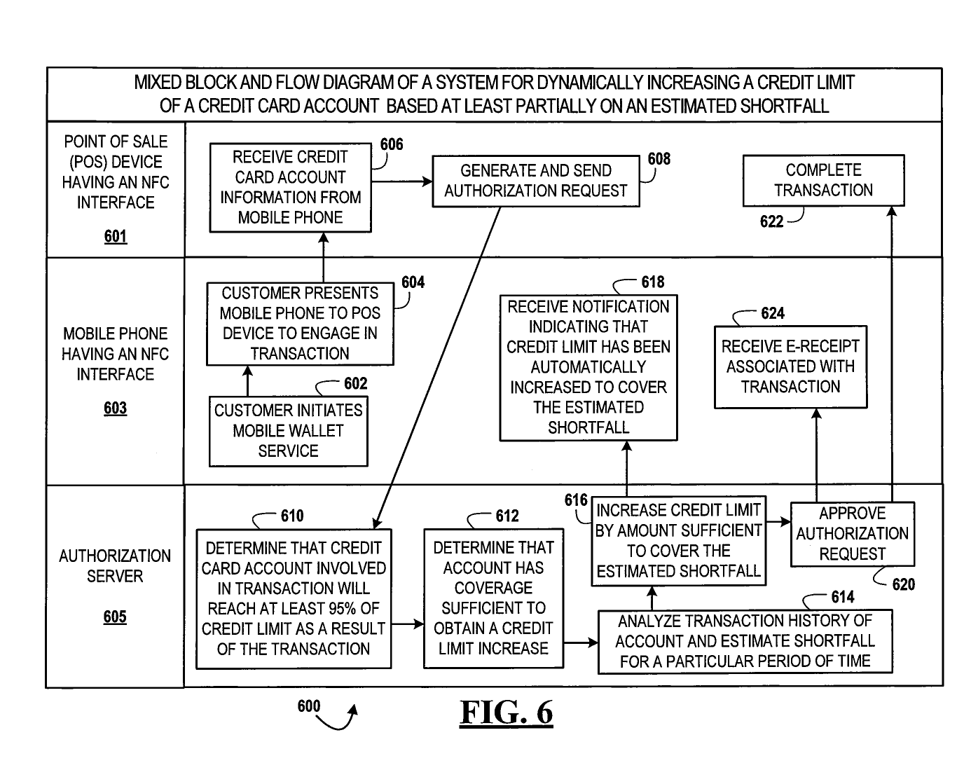

The system 400 and/or one or more portions of the system 400 may include and/or implement any embodiment of the present invention described and/or contemplated herein. For example, in some embodiments, the system 400 (and/or one or more portions of the system 400) is configured to implement any one or more embodiments of the process flow 100 described and/or contemplated herein in connection with FIG. 1, any one or more embodiments of the process flow 105 described and/or contemplated herein in connection with FIG. 1A, any one or more embodiments of the process flow 200 described and/or contemplated herein in connection with FIG. 2, any one or more embodiments of the process flow 300 described and/or contemplated herein in connection with FIG. 3, any one or more embodiments described and/or contemplated herein in connection with FIG. 5, and/or any one or more of embodiments of the process flow described and/or contemplated herein in connection with FIG. 6.

As a specific example, in accordance with an embodiment of the present invention, the authorization apparatus 430 is configured to: (a) receive transaction information associated with a transaction, where the transaction involves the credit account 408, the transaction machine 420, and the holder 402, and where the credit account has a credit limit, as represented by block 110 in FIG. 1; (b) determine, based at least partially on the transaction information, that at least a predetermined portion of the credit limit (e.g., 90%, over 100%, etc.) will be used as a result of the transaction, as represented by block 120; (c) determine that the credit account 408 is eligible for a credit limit increase (e.g., based at least partially on the transaction history 408B and/or the coverage information 408D, etc.), as represented by block 130; (d) increase the credit limit of the credit account 408 (e.g., by an amount so that the account will have available credit sufficient to cover the transaction), as represented by block 140; (e) determine that, as a result of the credit limit increase, the credit account 408 has available credit sufficient to cover the transaction, as represented by block 150; and (f) authorize the transaction based at least partially on determining that the credit account has sufficient available credit, as represented by block 160.

In accordance with some embodiments, the transaction machine 420, the authorization apparatus 430, and/or the mobile device 440 are each configured to send and/or receive one or more instructions to and/or from each other, such that an instruction sent, for example, from the authorization apparatus 430 to the transaction machine 420 (and/or vice versa) can trigger the transaction machine 420 (and/or vice versa) to perform one or more portions of any one or more of the embodiments described and/or contemplated herein.

Referring now to FIG. 5, a mixed block and flow diagram of a system 500 is provided for dynamically increasing a credit limit of a credit card account based at least partially on a transaction amount, in accordance with an exemplary embodiment of the present invention. It will be understood that the system 500 illustrated in FIG. 5 represents an example embodiment of the process flow 100 described in connection with FIG. 1. As shown, the system 500 includes a POS device 501 (e.g., the transaction machine 420, a merchant terminal, etc.), an authorization server 503 (e.g., the authorization apparatus 430, etc.), and a mobile phone 505 (e.g., the mobile device 440, etc.). The POS device 501, the authorization server 503, and the mobile phone 505 may each include a communication interface, a user interface, a processor, a memory, an application, and/or a datastore, and those components may be operatively connected to each other.

In accordance with some embodiments, the POS device 501 and the mobile phone 505 are operatively and selectively connected to the authorization server 503 via one or more networks (not shown). For example, in some embodiments, the POS device 501 is operatively connected to the authorization server 503 via a payment network, and/or the mobile phone 505 is operatively connected to the authorization server 503 via a telephone network. Also, in this example embodiment, the POS device 501 and the mobile phone 505 are accessible to a customer of a financial institution (not shown). Also, the POS device 501 is maintained by a merchant, the mobile phone 505 is maintained by the customer of the financial institution, and the authorization server 503 is maintained by the financial institution. Further, in accordance with some embodiments, the financial institution maintains the credit card account held by the customer and associated with the credit card mentioned below.

As represented by block 502, in this example embodiment, the customer swipes the credit card at the POS device 501 to engage in a $500 credit card transaction involving the customer and the merchant. Although not shown, the POS device 501 may also authenticate the customer based at least partially on one or more credentials the customer provides to the POS device 501. Next, as represented by block 504, the POS device 501 generates and sends an authorization request associated with the credit card transaction to the authorization server 503. In accordance with some embodiments, the authorization request includes information that, for example, identifies the customer, the credit card account associated with the credit card, the amount of the transaction (i.e., $500), the one or more goods and/or services involved in the transaction, and/or the like. As represented by block 506, the authorization server 503 then determines that the credit card account associated with the credit card will go over limit by $200 as a result of the 500 transaction. Additionally or alternatively, in some embodiments, the apparatus determines that the credit card account has only $300 of credit available immediately prior to engaging in the $500 transaction. As a specific example involving a credit limit, the credit limit for the credit card account may be $3,000 and the amount of credit used immediately prior to the $500 transaction is $2,700, which means that the $500 transaction would result in the account going over limit by $300.

In this example embodiment, after making the over limit determination, the authorization server 503 determines that the credit card account (and/or the customer) is eligible for a $200 credit limit increase to cover the transaction, as represented by block 508. This eligibility determination can be made in any of the ways previously described herein. For example, in some embodiments, the server 503 is configured to make this eligibility determination based at least partially on a credit score of the customer and/or on the nature of the relationship between the customer and the financial institution. In addition, it will be understood that the credit limit increase described in this example embodiment may be temporary (e.g., where the credit limit is reduced back to the original level in the next statement cycle, etc.) or permanent (e.g., where the credit limit is maintained at the increased level for the next one or more statement cycles, etc.).

After determining that the account (and/or customer) is eligible for the credit limit increase, the authorization server 503, in this example embodiment, identifies a phone number associated with the credit card account (and/or the customer), as represented by block 510. For example, in some embodiments, the server 503 retrieves the phone number from an account profile associated with the credit card account, where the account profile is stored in a computer-readable medium (e.g., which may reside in the server 503, etc.).

After the authorization server 503 identifies the phone number, the authorization server 503 sends a text message (e.g., SMS message, MMS message, EMS message, etc.) to the phone number, which corresponds to the mobile phone 505, as represented by block 512. In this example embodiment, the text message received by the mobile phone 505 notifies the customer of the over limit transaction and prompts the customer to consent to the $200 credit limit increase to cover the transaction. In some embodiments, the text message received by the mobile phone 505 is delivered visually to the customer via a display of the mobile phone 505. After reading the text message at the mobile phone 505, the customer sends, via a second text message, his consent to the $200 credit limit increase back to the authorization server 503, as represented by block 514. For example, in some embodiments, the customer sends a “Yes” SMS message to a financial institution phone number, where the phone number was provided in the SMS message originally sent from the authorization server 503. Additionally or alternatively, in some embodiments, the customer consenting the credit limit increase serves to indicate, either implicitly or explicitly, that the customer also consents to completing the transaction.

After the customer consents to the credit limit increase, the authorization server 503 stores the customer's consent (e.g., in a datastore residing in the authorization server 503), as represented by block 516. In addition, the authorization server 503 increases credit limit of the credit card account by $200, as represented by block 518. In some embodiments, the server 503 makes this credit limit increase only if the server 503 receives the customer's consent to the credit limit increase. After increasing the credit limit, the authorization server 503 approves the authorization request, as represented by block 520. In some embodiments, the authorization server 503 additionally determines that the account, as a result of the credit limit increase, has sufficient available credit to cover the $500 transaction. In such embodiments, the server 503 may approve the authorization request based at least partially on this determination.

After the authorization request has been approved, the transaction is completed at the POS device 501, as represented by block 522. For example, in some embodiments, the merchant approves the transaction, the merchant produces a receipt of the transaction for the customer, and/or the customer leaves the POS device 501 and/or the merchant's store. Also after approving the authorization request, the authorization server 503 is configured to generate and/or send a text message to the mobile phone 505, where the text message indicates that the credit limit for the credit card account has been increased by $200, as represented by block 524. In some embodiments, this message constitutes a receipt and/or confirmation of the credit limit increase.

Of course, the embodiment illustrated in FIG. 5 is merely exemplary and other embodiments may vary without departing from the scope and spirit of the present invention. For example, in some alternative embodiments, the authorization request is first declined by the authorization server 503, and the customer is required to re-swipe the credit card at the POS device 501 after consenting to the credit limit increase in order to generate and/or send a second authorization request and/or to complete the transaction. Thus, it will be understood that the authorization request approved at block 520 may be the original authorization request sent or a later authorization request sent after the customer consents to the credit limit increase. As another example, in some alternative embodiments, one or more portions of the process flow being performed by the mobile phone 505 are performed instead by the POS device 501. For example, in some alternative embodiments, the customer is prompted to consent to the credit limit increase via the POS device 501 (e.g., via a user interface associated with the POS device 501) and/or the customer consents to the credit limit increase via the POS device 501. As still another example, in some alternative embodiments, the amount of the credit limit increase is greater than the over limit amount (e.g., the server 503 determines a credit limit increase of $1,000 instead of only $200). As yet another example, in some alternative embodiments, the customer is not prompted to consent to increasing the credit limit and/or is not notified at all during the transaction; instead, in such embodiments, the authorization server 503 may automatically increase the credit limit and approve the authorization request, all after and/or based at least partially on making the eligibility determination. In such embodiments, the customer may not know of the over limit determination and/or credit limit increase until after the transaction is authorized and/or completed (e.g., until the customer receives the message, as represented by block 524).

Also, in some embodiments, one or more of the portions of the process flow represented by blocks 502-524 are triggered by one or more triggering events, which, in some embodiments, include the performance of one or more of the other portions of the process flow represented by blocks 502-524. Also, in some embodiments, the system 500 is configured to perform the entire process flow represented by blocks 502-524, from start to finish, within moments, seconds, and/or minutes. For example, in some embodiments, the customer consents to the credit limit increase within approximately three minutes of the authorization server 503 receiving the authorization request from the POS device 501.

Referring now to FIG. 6, a mixed block and flow diagram of a system 600 is provided for dynamically increasing a credit limit of a credit card account based at least partially on an estimated shortfall, in accordance with an exemplary embodiment of the present invention. It will be understood that the system 600 illustrated in FIG. 6 represents an example embodiment of the process flow 100 described in connection with FIG. 1. As shown, the system 600 includes a POS device 601 having an NFC interface, a mobile phone 603 having an NFC interface, and an authorization server 605. The POS device 601, the mobile phone 603, and the authorization server 605 may each include a communication interface, a user interface, a processor, a memory, an application, and/or a datastore, and those components may be operatively connected to each other.

In accordance with some embodiments, the POS device 601 and the mobile phone 603 are operatively and selectively connected to the authorization server 605 via one or more networks (not shown). For example, in some embodiments, the POS device 601 is operatively connected to the authorization server 605 via a payment network, and/or the mobile phone 603 is operatively connected to the authorization server 605 via a telephone network. In addition, the NFC interface of the mobile phone 603 and the NFC interface of the POS device 601 enable the mobile phone 603 to wirelessly and/or contactlessly communicate with the POS device 601. Specifically, in this example embodiment, the mobile phone 603 includes an RF transmitter that is configured to wirelessly and/or contactlessly communicate account and/or transaction information to an NFC reader associated with the POS device 601. Accordingly, in this example embodiment, the mobile phone 603 is configured to operate as a mobile wallet.

It will be understood that the POS device 601 and the mobile phone 603 are accessible to the customer referred to in block 602. Also, in this example embodiment, the POS device 601 is maintained by a merchant, the mobile phone 603 is maintained by the customer of a bank, and the authorization server 605 is maintained by the bank. Further, in accordance with some embodiments, the bank maintains the credit card account held by the customer, and the mobile phone is associated with the credit card account.

As represented by block 602, the customer initiates a mobile wallet service on the mobile phone 603. In some embodiments, the mobile wallet service is embodied as a tool or feature of a mobile banking application that is installed and executes on the mobile phone 603. Additionally or alternatively, in some embodiments, the mobile wallet service requires the customer to be authenticated before providing the customer with access to the mobile wallet service. In some of these embodiments, the mobile wallet service is configured to authenticate the customer based at least partially on one or more credentials the customer provides to the mobile phone 603 and/or authorization server 605.

After initiating the mobile wallet service, the customer presents the mobile phone 603 to the POS device 601 to engage in the transaction, as represented by block 604. For example, in some embodiments, the customer “taps” the mobile phone 603 to the POS device 601 by holding the NFC interface of the mobile phone 603 within a relatively short range of (e.g., within approximately four inches of, etc.) the NFC interface of the POS device 601. When the mobile phone 603 is presented to the POS device 601, the POS device 601 receives credit card account information from the mobile phone 603, as represented by block 606. Thereafter, the POS device 601 generates and sends an authorization request associated with the transaction to the authorization server 605, as represented by block 608. In accordance with some embodiments, the authorization request includes information that, for example, identifies the customer, the credit card account associated with the mobile phone, the amount of the transaction, the one or more goods and/or services involved in the transaction, and/or the like.

After receiving the authorization request, as represented by block 610, the authorization server 605 determines that the credit card account involved in the transaction will reach at least 95% (and/or some other predetermined portion) of its credit limit as a result of the transaction. After this determination, the authorization server 605 determines that the credit card account has coverage sufficient to obtain a credit limit increase, as represented by block 612. For example, in some embodiments, the authorization server 605 accesses the account profile for the credit card account and determines that the account is current on its premium payments to obtain a future credit limit increase.

After making the coverage determination, the authorization server 605 receives and analyzes the transaction history of the credit card account and estimates a shortfall for a particular period of time, as represented by block 614. For example, in some embodiments, the server 605 determines, based at least partially on the transaction history, that the credit card account is typically used to make a car payment on the day of the month that happens to be two days after the date of the transaction referred to in FIG. 6. Accordingly, in such embodiments, the server 605 may determine an amount for the credit limit increase that will be enough to cover the predicted upcoming car payment (assuming that the account will not have enough available credit to cover the car payment after the transaction referred to in FIG. 6 is completed). Of course, it will be understood that the server 605 can be configured to estimate a shortfall that includes other types of recurring payments and/or one-time payments. In addition, it will be understood that the server 605 can be configured to estimate a shortfall for any future period of time. For example, in some embodiments, the server 605 is configured to estimate the shortfall of the account for the rest of the day, for the rest of the week, for the rest of the month, and so on.

After the authorization server 605 estimates the shortfall for the account for the particular period of time, the server 605 is configured to increase the credit limit for the account by an amount sufficient to cover the estimated shortfall. In some embodiments, this means that the server 605 increases the credit limit by the exact amount of the shortfall. In other embodiments, the server 605 increases the credit limit by the amount of the shortfall minus the amount of credit available to the credit card account after the transaction referred to in FIG. 6 is completed. As another example, in some embodiments, the server 605 increases the credit limit by the estimated shortfall plus $200. It will be understood that the credit limit increase referred to in block 616 can be temporary or permanent.

After increasing the credit limit, the authorization server 605 approves the authorization request, as represented by block 620, and the transaction is completed at the POS device 601, as represented by block 622. In addition, the authorization server 605 is configured to generate and/or send a notification to the mobile phone 603, where the notification indicates that the credit limit has been automatically increased by an amount sufficient to cover the estimated shortfall, as represented by block 618. In some embodiments, the notification identifies the amount of the credit limit increase, the reason(s) for the credit limit increase (e.g., based on the coverage, based on reaching at least 95% of the credit limit, etc.), and/or whether the credit limit increase is temporary or permanent. Further, after approving the authorization request, the server 603 is configured to generate and/or send an electronic receipt that memorializes the transaction to the mobile phone 603. In some embodiments, the notification and/or e-receipt received by the mobile phone 603 is delivered visually to the customer via a display of the mobile phone 603 and/or audibly via a speaker of the mobile phone 603.

Of course, the embodiment illustrated in FIG. 6 is merely exemplary and other embodiments may vary without departing from the scope and spirit of the present invention. For example, in some alternative embodiments, the customer is required to re-present (and/or “re-tap”) the mobile phone 603 at the POS device 601 in order to indicate the customer's consent to completing the transaction. In some of these embodiments, the customer is prompted to re-present the mobile phone 603 by the notification of the credit limit increase. As another example, in some alternative embodiments, the customer must consent to the credit limit increase before the server 605 will increase the credit limit and/or approve the authorization request. In some of these embodiments, the server 605 is configured to prompt the customer, during the transaction, to consent to the credit limit increase via the mobile phone 603 and/or the POS device 601. In some of these embodiments, the customer consents to the credit limit increase during the transaction and via the mobile phone 603 and/or POS device 601.

Also, in some embodiments, one or more of the portions of the process flow represented by blocks 602-624 are triggered by one or more triggering events, which, in some embodiments, include the performance of one or more of the other portions of the process flow represented by blocks 602-624. Also, in some embodiments, the system 600 is configured to perform the entire process flow represented by blocks 602-624, from start to finish, within moments, seconds, and/or minutes. For example, in some embodiments, the authorization server 605 estimates the shortfall, increases the credit limit, and/or approves the authorization request within approximately 1-5 minutes of the server 605 receiving the authorization request from the POS device 601.

Although many embodiments of the present invention have just been described above, the present invention may be embodied in many different forms and should not be construed as limited to the embodiments set forth herein; rather, these embodiments are provided so that this disclosure will satisfy applicable legal requirements. Also, it will be understood that, where possible, any of the advantages, features, functions, devices, and/or operational aspects of any of the embodiments of the present invention described and/or contemplated herein may be included in any of the other embodiments of the present invention described and/or contemplated herein, and/or vice versa. In addition, where possible, any terms expressed in the singular form herein are meant to also include the plural form and/or vice versa, unless explicitly stated otherwise. Accordingly, the terms “a” and/or “an” shall mean “one or more,” even though the phrase “one or more” is also used herein. Like numbers refer to like elements throughout.

As will be appreciated by one of ordinary skill in the art in view of this disclosure, the present invention may include and/or be embodied as an apparatus (including, for example, a system, machine, device, computer program product, and/or the like), as a method (including, for example, a business method, computer-implemented process, and/or the like), or as any combination of the foregoing. Accordingly, embodiments of the present invention may take the form of an entirely business method embodiment, an entirely software embodiment (including firmware, resident software, micro-code, etc.), an entirely hardware embodiment, or an embodiment combining business method, software, and hardware aspects that may generally be referred to herein as a “system.” Furthermore, embodiments of the present invention may take the form of a computer program product that includes a computer-readable storage medium having one or more computer-executable program code portions stored therein. As used herein, a processor, which may include one or more processors, may be “configured to” perform a certain function in a variety of ways, including, for example, by having one or more general-purpose circuits perform the function by executing one or more computer-executable program code portions embodied in a computer-readable medium, and/or by having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, electromagnetic, infrared, and/or semiconductor system, device, and/or other apparatus. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as, for example, a propagation signal including computer-executable program code portions embodied therein.

One or more computer-executable program code portions for carrying out operations of the present invention may include object-oriented, scripted, and/or unscripted programming languages, such as, for example, Java, Perl, Smalltalk, C++, SAS, SQL, Python, Objective C, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

Some embodiments of the present invention are described herein with reference to flowchart illustrations and/or block diagrams of apparatuses and/or methods. It will be understood that each block included in the flowchart illustrations and/or block diagrams, and/or combinations of blocks included in the flowchart illustrations and/or block diagrams, may be implemented by one or more computer-executable program code portions. These one or more computer-executable program code portions may be provided to a processor of a general purpose computer, special purpose computer, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

The one or more computer-executable program code portions may be stored in a transitory and/or non-transitory computer-readable medium (e.g., a memory, etc.) that can direct, instruct, and/or cause a computer and/or other programmable data processing apparatus to function in a particular manner, such that the computer-executable program code portions stored in the computer-readable medium produce an article of manufacture including instruction mechanisms which implement the steps and/or functions specified in the flowchart(s) and/or block diagram block(s)

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with, and/or replaced with, operator- and/or human-implemented steps in order to carry out an embodiment of the present invention.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations, modifications, and combinations of the just described embodiments can be configured without departing from the scope and spirit of the invention. Therefore, it is to be understood that, within the scope of the appended claims, the invention may be practiced other than as specifically described herein.

What is claimed is:

1. A method comprising:
receiving transaction information associated with a transaction, wherein the transaction involves a credit account, and wherein the credit account comprises a credit limit;
determining, based at least partially on the transaction information, that at least a predetermined portion of the credit limit will be used as a result of the transaction; and
increasing the credit limit based at least partially on the determining that at least the predetermined portion of the credit limit will be used.

2. The method of claim 1, further comprising:
authorizing the transaction after the increasing the credit limit.

3. The method of claim 2, further comprising:
determining that, as a result of the increasing the credit limit, the credit account comprises available credit sufficient to cover the transaction,
wherein the authorizing the transaction is based at least partially on the determining that the credit account comprises sufficient available credit.

4. The method of claim 1, further comprising:
authorizing the transaction before the increasing the credit limit.

5. The method of claim 4, further comprising:
determining that the credit limit will be increased so that the account will comprise available credit sufficient to cover the transaction, and
wherein the authorizing the transaction is based at least partially on the determining that the credit limit will be increased.

6. The method of claim 1, wherein the predetermined portion of the credit limit is the total credit limit, and wherein the determining that at least the predetermined portion of the credit limit will be used comprises determining that that the total credit limit will be exceeded as a result of the transaction.

7. The method of claim 1, further comprising:
determining that the credit account is eligible for a credit limit increase,
wherein the increasing the credit limit is based at least partially on the determining that the credit account is eligible for the credit limit increase.

8. The method of claim 7, further comprising:
receiving one or more premium payments for purchasing coverage to obtain a future credit limit increase, wherein the one or more premium payments are associated with the credit account, and wherein the receiving the one or more premium payments occurs before the transaction is initiated; and
recording coverage information in a computer-readable medium based at least partially the receiving the one or more premium payments, wherein the coverage information indicates that the credit account has coverage sufficient to obtain a future credit limit increase,
wherein the determining that the credit account is eligible for a credit limit increase is based at least partially on the coverage information.

9. The method of claim 1, wherein the transaction involves a holder of the credit account, the method further comprising:
prompting the holder to consent to a credit limit increase; and
receiving the holder's consent to the credit limit increase,
wherein the increasing the credit limit is based at least partially on the receiving the holder's consent.

10. The method of claim 9, wherein the prompting the holder to consent to the credit limit increase occurs within approximately thirty seconds of the determining that at least a predetermined portion of the credit limit will be used as a result of the transaction.

11. The method of claim 9, wherein the prompting the holder to consent to the credit limit increase comprises sending a message to a mobile device accessible to the holder, wherein the message prompts the holder to consent to the credit limit increase.

12. The method of claim 11, wherein the mobile device is a mobile phone carried by the holder during the transaction, and wherein the receiving the holder's consent comprises receiving the holder's consent via the mobile phone.

13. The method of claim 9, wherein the transaction involves a transaction machine, and wherein the prompting the holder to consent to the credit limit increase comprises sending a message to the transaction machine, wherein the message prompts the holder to consent to the credit limit increase.

14. The method of claim 1, further comprising:
assessing the credit account a service fee based at least partially on the increasing the credit limit.

15. The method of claim 1, further comprising:
receiving second transaction information associated with a second transaction, wherein the second transaction involves a second credit account and a holder of the second credit account, and wherein the second credit account comprises a second credit limit;
determining, based at least partially on the second transaction information, that at least a predetermined portion of the second credit limit will be used as a result of the second transaction;
prompting the holder to consent to a credit limit increase;
receiving a notification that indicates that the holder does not consent to the credit limit increase; and
declining the second transaction based at least partially on the receiving the notification.

16. The method of claim 1, further comprising:
receiving a transaction history associated with the credit account; and
determining, based at least partially on the transaction history, a shortfall for the credit account over a future period of time,
wherein the increasing the credit limit comprises increasing the credit limit based at least partially on the shortfall.

17. The method of claim 1, wherein the transaction involves a holder of the credit account, the method further comprising:
prompting the holder to select an amount for a credit limit increase; and
receiving the holder's selected amount for the credit limit increase,
wherein the increasing the credit limit comprises increasing the credit limit based at least partially on the selected amount.

18. The method of claim 17, wherein the prompting the holder occurs before the receiving the transaction information.

19. The method of claim 17, wherein the prompting the holder occurs after the receiving the transaction information and before the increasing the credit limit.

20. The method of claim 1, wherein the increasing the credit limit comprises increasing the credit limit by the difference between the transaction amount and the amount of credit available to the credit account immediately prior to the transaction.

21. An apparatus comprising:
a communication interface configured to receive, via a payment network, transaction information associated with a transaction, wherein the transaction involves a credit account, and wherein the credit account comprises a credit limit; and
a processor operatively connected to the communication interface and configured to:
determine, based at least partially on the transaction information, that at least a predetermined portion of the credit limit will be used as a result of the transaction; and
increase the credit limit based at least partially on the processor determining that at least the predetermined portion of the credit limit will be used.

22. The apparatus of claim 21, wherein the processor is further configured to:
authorize the transaction after the processor increases the credit limit.

23. The apparatus of claim 22, wherein the apparatus is further configured to:
determine that, as a result of the processor increasing the credit limit, the credit account comprises available credit sufficient to cover the transaction,
wherein the processor authorizing the transaction is based at least partially on the processor determining that the credit account comprises sufficient available credit.

24. The apparatus of claim 21, wherein the processor is further configured to:
authorize the transaction before the processor increases the credit limit.

25. The apparatus of claim 24, wherein the processor is further configured to:
determine that the credit limit will be increased so that the account will comprise available credit sufficient to cover the transaction, and
wherein the processor authorizing the transaction is based at least partially on the processor determining that the credit limit will be increased.

26. The apparatus of claim 21, wherein the processor is further configured to:
determine that the credit account is eligible for a credit limit increase,
wherein the processor increasing the credit limit is based at least partially on the processor determining that the credit account is eligible for the credit limit increase.

27. The apparatus of claim 26, further comprising:
a memory device operatively connected to the processor and configured to store coverage information associated with the credit account, wherein the coverage information indicates that the credit account has coverage sufficient to obtain a future credit limit increase, and
wherein the processor determining that the credit account is eligible for a credit limit increase is based at least partially on the coverage information.

28. The apparatus of claim 21, wherein the transaction involves a holder of the credit account, and wherein the processor is further configured to:
prompt the holder to consent to a credit limit increase; and
receive the holder's consent to the credit limit increase,
wherein the processor increasing the credit limit is based at least partially on the processor receiving the holder's consent.

29. The apparatus of claim 21, wherein the communication interface is further configured to receive second transaction information associated with a second transaction, wherein the second transaction involves a second credit account and a holder of the second credit account, and wherein the second credit account comprises a second credit limit, and
wherein the processor is further configured to:
determine, based at least partially on the second transaction information, that at least a predetermined portion of the second credit limit will be used as a result of the second transaction;
prompt the holder to consent to a credit limit increase;
receive a notification that indicates that the holder does not consent to the credit limit increase; and
decline the second transaction based at least partially on the processor receiving the notification.

30. The apparatus of claim 21, wherein the processor is further configured to:
receive a transaction history associated with the credit account; and
determine, based at least partially on the transaction history, a shortfall for the credit account over a future period of time,
wherein the processor increasing the credit limit comprises the processor increasing the credit limit based at least partially on the shortfall.

31. The apparatus of claim 21, wherein the transaction involves a holder of the credit account, and wherein the processor is further configured to:
prompt the holder to select an amount for a credit limit increase; and
receive the holder's selected amount for the credit limit increase,
wherein the processor increasing the credit limit comprises processor increasing the credit limit based at least partially on the selected amount.

32. A computer program product comprising a non-transitory computer-readable medium, wherein the non-transitory computer-readable medium comprises one or more computer-executable program code portions that, when executed by a computer, cause the computer to:
receive transaction information associated with a transaction, wherein the transaction involves a credit account, and wherein the credit account comprises a credit limit;
determine, based at least partially on the transaction information, that at least a predetermined portion of the credit limit will be used as a result of the transaction;
increase the credit limit based at least partially on the computer determining that at least the predetermined portion of the credit limit will be used; and
authorize the transaction based at least partially on the computer increasing the credit limit.

33. The computer program product of claim 32, wherein the one or more computer-executable program code portions, when executed by the computer, cause the computer to:
determine that, as a result of the computer increasing the credit limit, the credit account comprises available credit sufficient to cover the transaction,
wherein the computer authorizing the transaction is based at least partially on the computer determining that the credit account comprises sufficient available credit.

34. The computer program product of claim 32, wherein the one or more computer-executable program code portions, when executed by the computer, cause the computer to:
determine that the credit account is eligible for a credit limit increase,
wherein the computer increasing the credit limit is based at least partially on the computer determining that the credit account is eligible for the credit limit increase.

35. The computer program product of claim 32, wherein the one or more computer-executable program code portions, when executed by the computer, cause the computer to:
prompt the holder to consent to a credit limit increase; and
receive the holder's consent to the credit limit increase,
wherein the computer increasing the credit limit is based at least partially on the computer receiving the holder's consent.

36. The computer program product of claim 32, wherein the one or more computer-executable program code portions, when executed by the computer, cause the computer to:
receive second transaction information associated with a second transaction, wherein the second transaction involves a second credit account and a holder of the second credit account, and wherein the second credit account comprises a second credit limit;
determine, based at least partially on the second transaction information, that at least a predetermined portion of the second credit limit will be used as a result of the second transaction;
prompt the holder to consent to a credit limit increase;
receive a notification that indicates that the holder does not consent to the credit limit increase; and
decline the second transaction based at least partially on the computer receiving the notification.

37. The computer program product of claim 32, wherein the one or more computer-executable program code portions, when executed by the computer, cause the computer to:
prompt the holder to select an amount for a credit limit increase; and
receive the holder's selected amount for the credit limit increase,
wherein the computer increasing the credit limit comprises the computer increasing the credit limit based at least partially on the selected amount.

38. A method comprising:
receiving an authorization request associated with a transaction, wherein the transaction involves a holder of a credit account and the credit account, and wherein the credit account comprises a credit limit;
determining that the account does not have available credit sufficient to cover the transaction;
prompting, during the transaction, the holder to consent to a credit limit increase, wherein the prompting occurs after the determining that the account does not have sufficient available credit;
receiving, during the transaction, the holder's consent to the credit limit increase; and
increasing the credit limit such that the account has available credit sufficient to cover the transaction, wherein the increasing the credit limit is based at least partially on the receiving the holder's consent.

39. The method of claim 38, further comprising:
approving the authorization request based at least partially on the increasing the credit limit.

40. The method of claim 38, further comprising:
approving the authorization request before the increasing the credit limit and based at least partially on the receiving the holder's consent.

41. A method comprising:
presenting, by a holder of an account, account information at a transaction machine to engage in a transaction, wherein the account information is associated with a credit account involved in the transaction, and wherein the credit account comprises a credit limit;
receiving, by the holder and via a mobile device carried by the holder, a communication that indicates that the credit account does not have sufficient available credit to complete the transaction, wherein the receiving occurs while the holder is still at the transaction machine; and
consenting, by the holder and via the mobile device, to increasing the credit limit to complete the transaction, wherein the consenting occurs while the holder is still at the transaction machine.

42. The method of claim 41, wherein the communication further prompts the holder to consent to increasing the credit limit to complete the transaction.

43. The method of claim 41, further comprising:
receiving, by the holder and via the mobile device, a communication that prompts the holder to re-present the account information at the transaction machine to complete the transaction; and
re-presenting, by the holder, the account information at the transaction machine.

44. The method of claim 41, wherein the presenting the account information comprises at least one of swiping a credit card associated with the credit account at the transaction machine or tapping a mobile phone associated with the credit account at the transaction machine.
